(19) United States
(12) Patent Application Publication
(10) Pub. No.: US 2001/0029475 A1
(43) Pub. Date: Oct. 11, 2001

(54) Financial processing system and method

(76) Inventors: Edward Boicourt, Silver Spring, MD (US); Joan Boicourt, Silver Spring, MD (US)

Correspondence Address: EPSTEIN, EDELL, SHAPIRO & FINNAN, LLC, 1901 Research Boulevard, Suite 400, Rockville, MD, 20850-3164, US

(21) Appl. No.: 09/788,167

(22) Filed: Feb. 16, 2001

Related U.S. Application Data
(60) Provisional application No. 60/183,364, filed on Feb. 18, 2000.

(51) Int. Cl. G06F 17/60

(52) U.S. Cl. 705/30

(57) ABSTRACT

A financial processing system according to the present invention includes a computer system and an integrated set of software functions and procedures that construct a multidimensional array to be used to enter and/or modify various types of data, provide the data to an output device and store the data permanently on a hard disk, tape or other similar storage device. The computer system is utilized in connection with the design, installation, creation, updating and reporting of financial information in diverse applications including trial balance, general ledger, financial analysis, financial reports, tax returns and workpapers (e.g., spreadsheets). The diverse applications may be accessed by a user via menus and appropriate keyboard and/or mouse entries. In addition, the workpapers and reports may be selectively configured by a user to accommodate various formats of and/or display user selected information.

### CROSS REFERENCE TO RELATED APPLICATIONS

This application claims priority from U.S. Provisional Patent Application Ser. No. 60/183,364, entitled “Financial Processing System and Method” and filed Feb. 18, 2000. The disclosure of that provisional application is incorporated herein by reference in its entirety.

### BACKGROUND OF THE INVENTION

1. Technical Field

The present invention pertains to a financial processing system and method for performing various business and financial related applications.

2. Discussion of the Related Art

Accounting and various other financial or business practices typically record financial information in order to provide and maintain an indication of a business financial status. Generally, information pertaining to each transaction of a business or other entity is initially recorded manually in financial journals with various amounts being transferred to accounting financial books or ledgers. The financial information contained within the journals and/or books may be utilized to produce statements indicating a business financial status (e.g., trial balance, etc.) or to provide financial information for other purposes (e.g., taxes, audits, etc.).

The manual collection and recording of financial information is generally a time consuming and tedious task. Further, once the information is recorded, calculations are typically applied to the financial information to manually produce various financial statements. In an attempt to enhance this process, the related art has provided various software packages for execution on computer systems to automate entry and recording of financial information and production of financial statements. The software packages each typically perform specific tasks and/or generate particular statements. For example, the individual software packages may respectively maintain checking and other financial accounts, produce invoice or billing statements, generate completed income tax forms and organize financial information in the form of spreadsheets. Certain software packages may further enable importation of information from other packages in response to user commands to utilize the transferred information for performance of additional financial tasks.

The related art suffers from several disadvantages. In particular, several software packages are typically required in order to perform different related financial tasks, thereby increasing system costs. Further, a user is typically required to repeatedly switch between the various software packages during performance of the related tasks, thereby degrading system efficiency and complicating processing of a financial activity. Moreover, since each software package utilizes memory and other computer system resources for execution, computer system performance and efficiency maybe significantly reduced by the additional software packages required to perform each of the related tasks. Although certain software packages may enable importation of information, the origin of the imported information is typically limited to particular software applications, while the packages and/or software applications are generally not interoperable. In addition, the software packages typically cannot automatically access information contained within or processed by other packages. This tends to limit the utilization of financial information and may cause different packages to contain or request from the user redundant financial information.

### OBJECTS AND SUMMARY OF THE INVENTION

Accordingly, it is an object of the present invention to perform various financial processing applications or tasks (e.g., journal processing, ledger processing, working trial balance, spreadsheet, tax form generation, etc.) within a computer system, thereby forming a comprehensive financial or accounting processing system.

It is another object of the present invention to include a set of software functions and procedures for performing financial applications within a financial processing system and enable a financial application to automatically access and utilize financial information of other financial applications performed by that system.

Yet another object of the present invention is to perform various financial processing applications via a computer system having a financial software package utilizing reduced amounts of memory.

The aforesaid objects are achieved individually and/or in combination, and it is not intended that the present invention be construed as requiring two or more of the objects to be combined unless expressly required by the claims attached hereto.

According to the present invention, a financial processing system includes a computer system and an integrated set of software functions and procedures which can construct a multidimensional array to be used to enter and/or modify various types of data and other information, provide it to an output device (e.g., display it on a computer monitor, print it on a printer, etc.) and store such data or information permanently on a hard disk, tape or other similar device. The computer system is utilized in connection with the design, installation, creation, updating and reporting of financial information in diverse applications including trial balance, general ledger, financial analysis, financial reports, tax returns and workpapers (e.g., spreadsheets). The computer system is preferably implemented by a properly programmed personal computer for use by an individual or small business, but the present invention is comprehensive and expandable such that it can be implemented on a main frame computer for use by very large entities, or it can be implemented in a local area network, a virtual private network, or in a wide area network, or it can be implemented in the internet or in an intranet. The diverse applications may be accessed by a user via menus and appropriate keyboard and/or mouse entries. In addition, the workpapers and reports may be selectively configured by a user to accommodate various formats of and/or display user selected information.

The above objects, features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1 is a schematic diagram of a system embodying the present invention.

FIG. 2 is a representation of an exemplary control file.

FIG. 3 is a representation of an exemplary note file.

FIG. 4 is a representation of an exemplary general ledger file.

FIG. 5 is a representation of an exemplary general journal file.

FIG. 6 is a representation of an exemplary beginning balance file.

FIG. 7 is a representation of an exemplary temporary transaction file.

FIG. 8 is a representation of an exemplary reports file.

FIG. 9 is a representation of an exemplary permanent transaction file.

FIG. 10 is a representation of an exemplary workpaper file.

FIG. 11 is a representation of an exemplary forms file.

FIG. 12 is a representation of an exemplary client list file.

FIGS. 13a, 13b and 13c are representations of exemplary arrays which contain data for constructing a browse port.

FIG. 14 is a representation of an exemplary Client/Project menu.

FIG. 15 is a representation of an exemplary menu of available pages of reports and forms.

FIG. 16 is a representation of an exemplary report page construction screen.

FIGS. 17a-17g are representations of exemplary arrays which contain data for constructing and displaying pages of reports and forms.

FIG. 18a is a representation of an exemplary main menu for Audit or Compilation Clients.

FIG. 18b is a representation of an exemplary main menu for Write-Up Clients.

FIG. 18c is a representation of an exemplary Project main menu.

FIG. 19 is a representation of an exemplary general ledger screen.

FIG. 20 is a representation of an exemplary general ledger account analysis screen.

FIG. 21a is a representation of an exemplary working trial balance (WTB) screen.

FIG. 21b is a representation of an exemplary add account screen.

FIG. 22a is a representation of an exemplary general journal screen.

FIG. 22b is a representation of an exemplary journal selection screen.

FIG. 22c is a representation of an exemplary cash receipts screen.

FIG. 22d is a representation of an exemplary cash disbursements screen.

FIG. 22e is a representation of an exemplary purchase journal screen.

FIG. 22f is a representation of an exemplary alphabet screen.

FIG. 22g is a representation of an exemplary header name screen.

FIG. 22h is a representation of an exemplary name display screen.

FIG. 22i is a representation of an exemplary vendor file.

FIG. 23 is a representation of exemplary arrays which contain data for constructing and displaying workpapers.

FIG. 24 is a representation of an exemplary workpapers menu.

FIGS. 25a-25b are representations of an exemplary workpaper construction screen.

FIG. 26 is a representation of an exemplary temporary array used to enter data for constructing a transaction record.

FIG. 27 is a representation of an exemplary What Type Client/Project screen.

### DETAILED DESCRIPTION OF THE PREFERRED EMBODIMENTS

The present invention includes an integrated set of software functions and procedures which can construct a multidimensional array to be used to enter and/or modify various types of data and other information, provide it to an output device (e.g., display it on a computer monitor, print it on a printer, etc.) and store such data or information permanently on a hard disk, tape or other similar device. The preferred embodiment of the present invention includes a computer system for use in connection with the design, installation, creation, updating and reporting of financial information in diverse applications including trial balance, general ledger, financial analysis, financial reports, tax returns and workpapers (e.g., spreadsheets). The present invention is preferably implemented by a properly programmed personal computer for use by an individual or small business, but is comprehensive and expandable such that it can be implemented on a main frame computer for use by very large entities, or it can be implemented in a local area network, a virtual private network, or in a wide area network, or it can be implemented in the internet or in an intranet.

A system embodying the present invention includes a structured set of data files, a structured set of arrays and computer software which includes procedures for entering, indexing and updating transaction files, procedures for creating new records and updating existing records in a general ledger file, procedures for creating and updating reports, procedures for creating and updating pages within those reports, and procedures for creating, maintaining and updating workpapers.

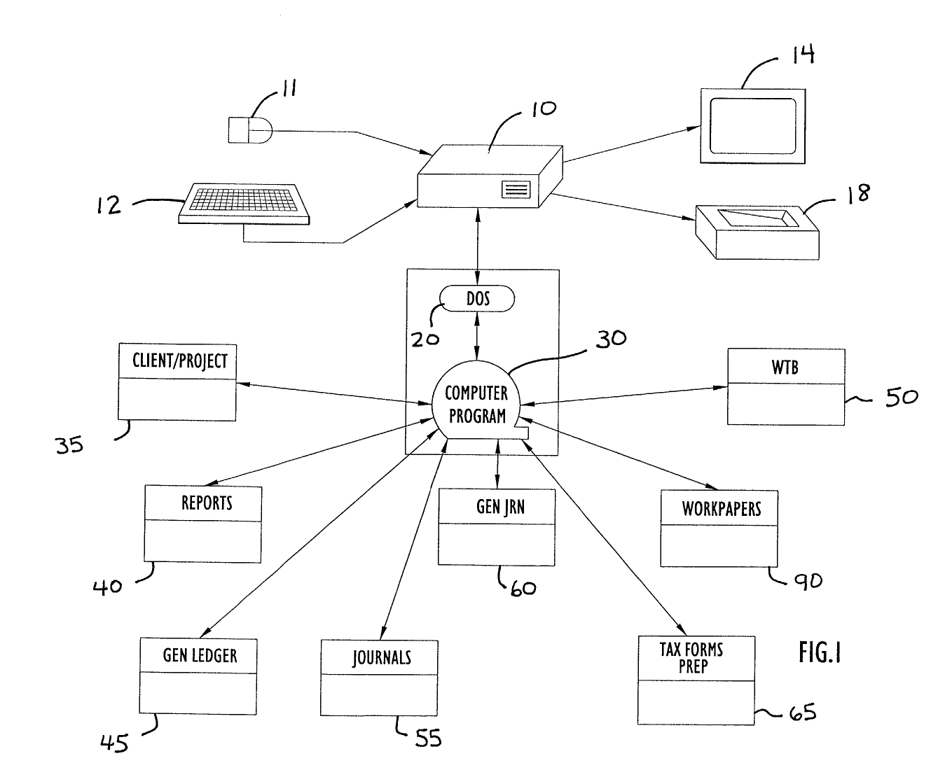

Referring to FIG. 1, there is shown a preferred embodiment of the automated recordkeeping, accounting, financial analysis and financial reporting system according to the present invention. Specifically, a computer program 30 for implementing several applications performed by the system, such as CLIENT/PROJECTS 35, REPORTS 40, GENERAL LEDGER 45, WORKING TRIAL BALANCE (WTB) 50, JOURNALS 55, GENERAL JOURNAL (GEN JRN) 60, TAX FORMS PREPARATION 65 and WORKPAPERS 90, is contained within a computer 10 having a DOS environment 20. Computer program 30 may be recorded on a suitable storage device, for example, a diskette, or can be resident on a hard disk in computer 10 or on a server computer comprising part of a local area network, a wide area network, a virtual private network or an intranet or the internet. The computer program is preferably implemented and compiled in the CA Clipper language, version 5.3 and linked with Blinker, version 3.20. The compile and link processes are typically accomplished in a DOS 6.22 environment on an Intel 486X type or other compatible machine.

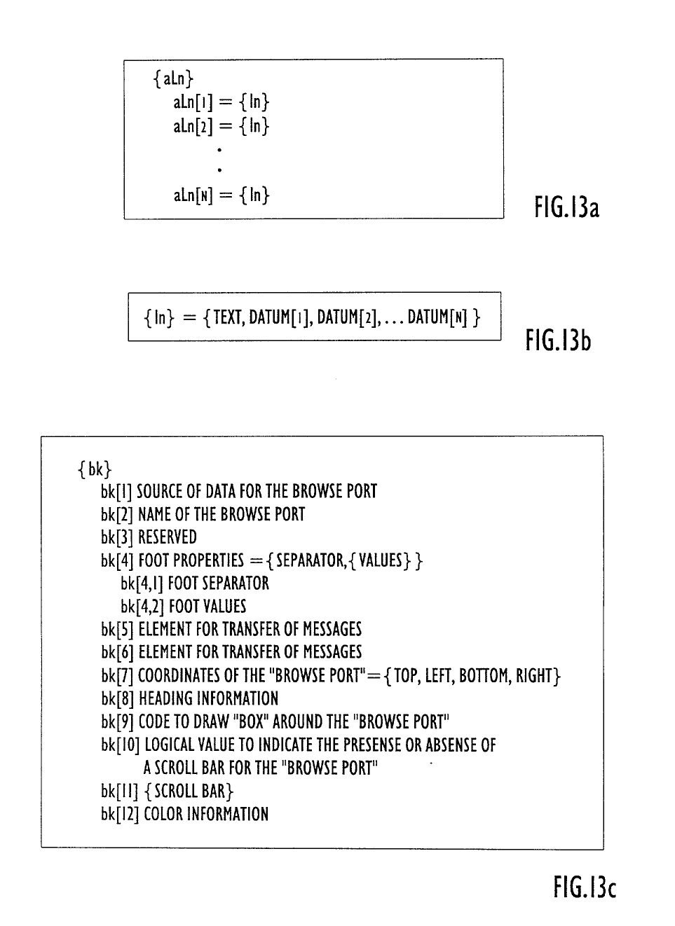

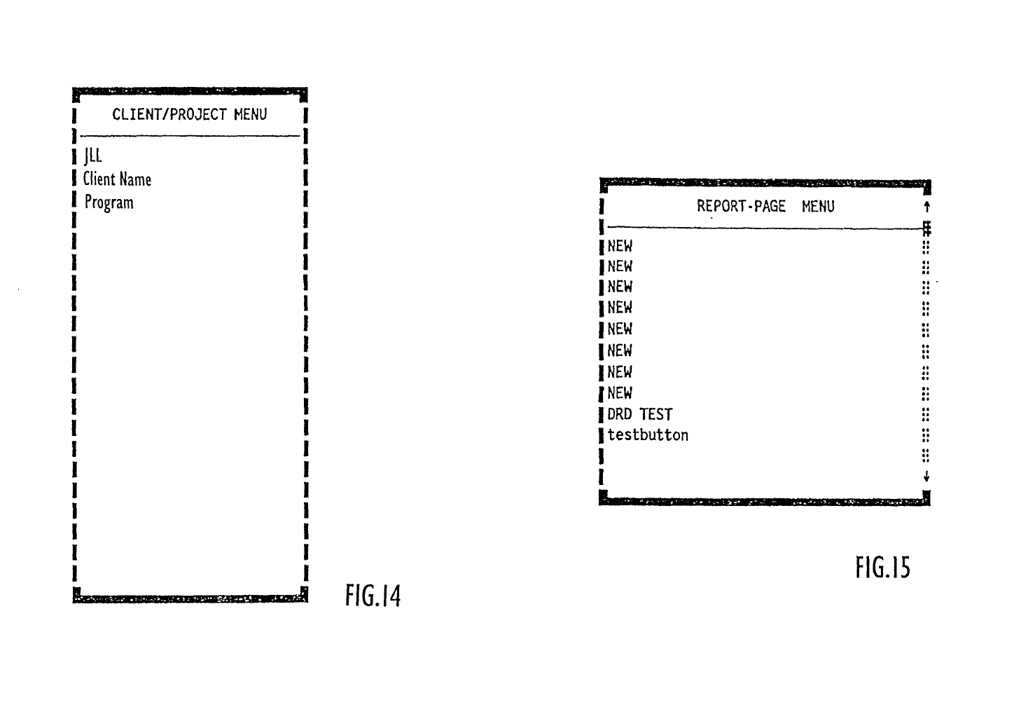

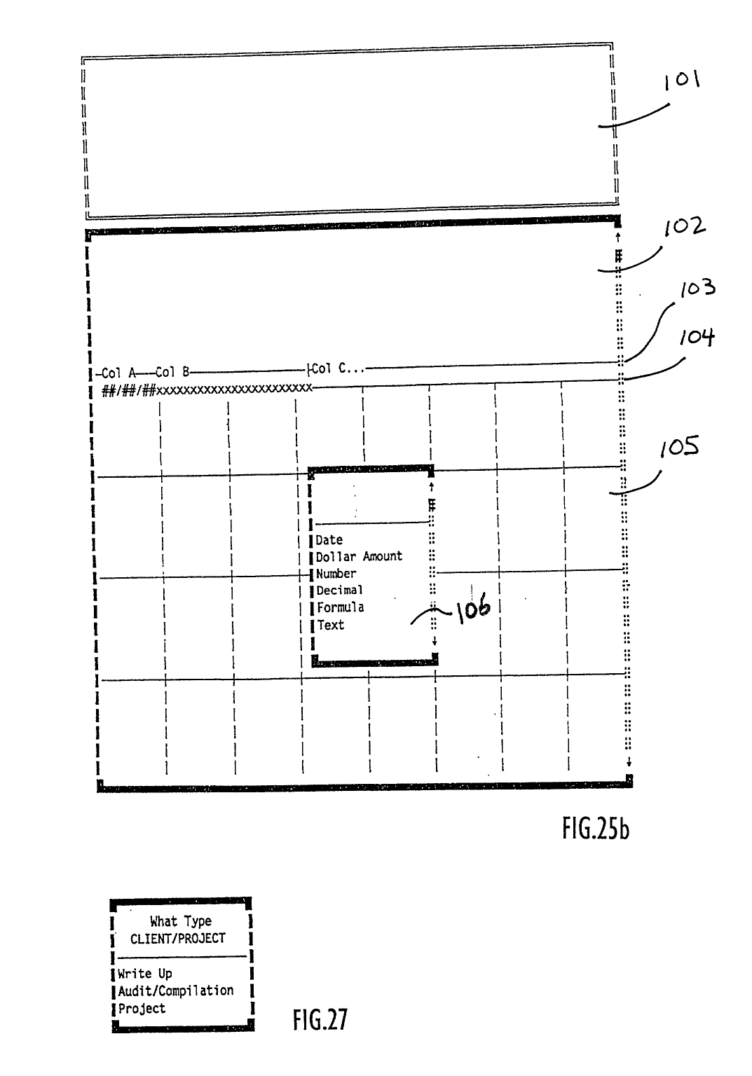

The “Browse Port” is the central, creative, manipulative instrument of the invention. It is used to collect, record, maintain, display and otherwise provide the content or data which is subject to the processes and procedures of this system. Visually, it occupies a generally rectangular area of a monitor screen 14. The area is defined in an array element designated bk[7] as described below. The content or data of the browse port is an array {aLn} described below for FIG. 13a. Other properties of the browse port are described below with reference to the array {bk} of FIG. 13c. A scroll bar, typically displayed on the right side of the browse port (e.g., as viewed in FIGS. 25a-25b), is provided by the Clipper language and is called by computer program 30 during construction of the browse port.

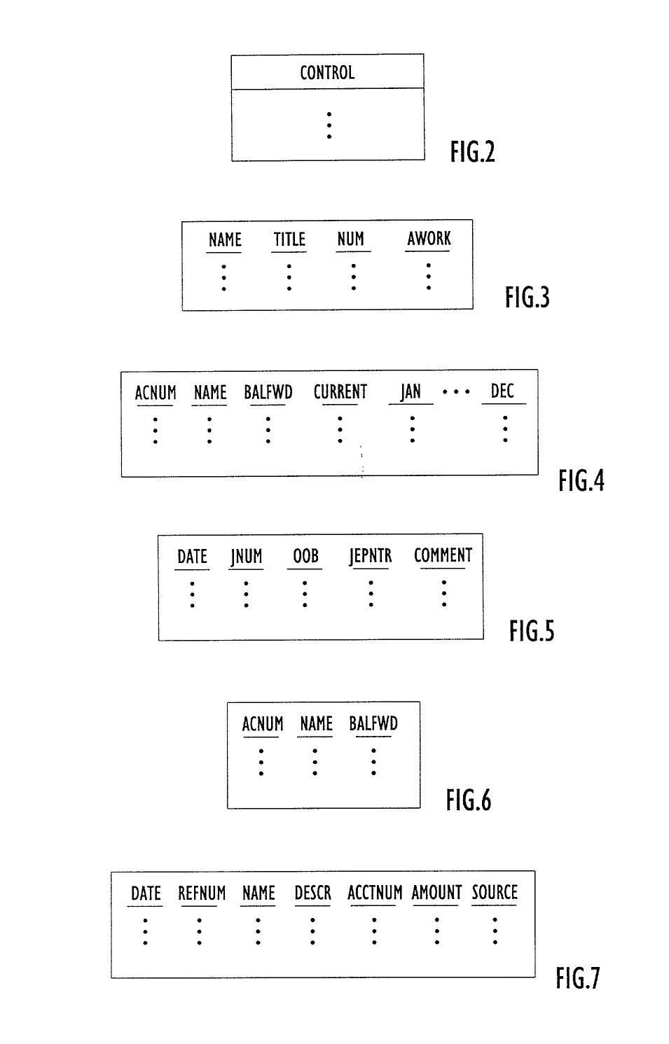

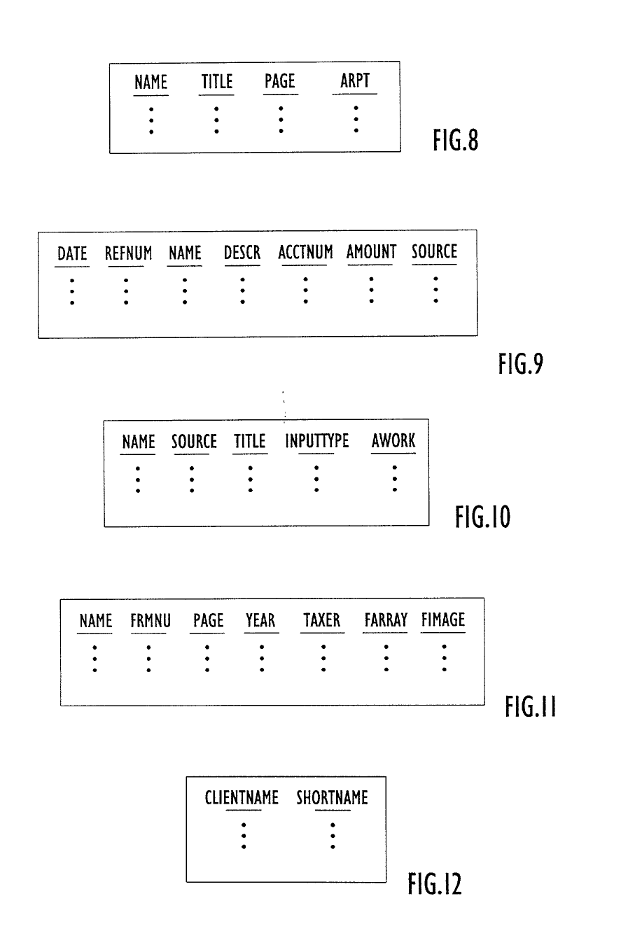

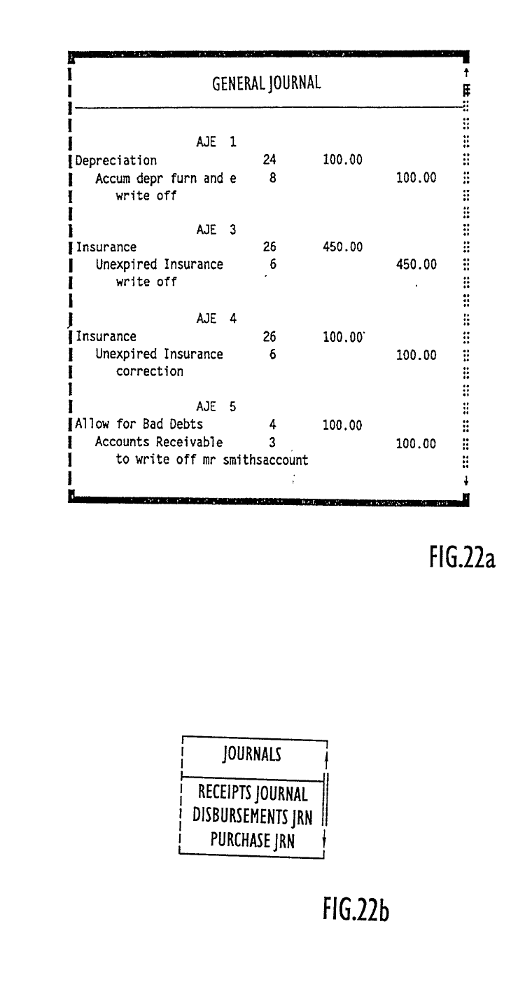

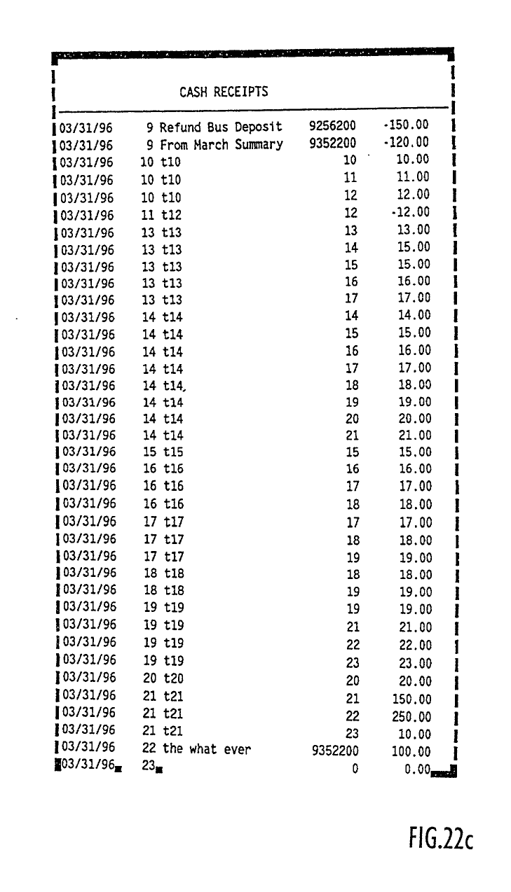

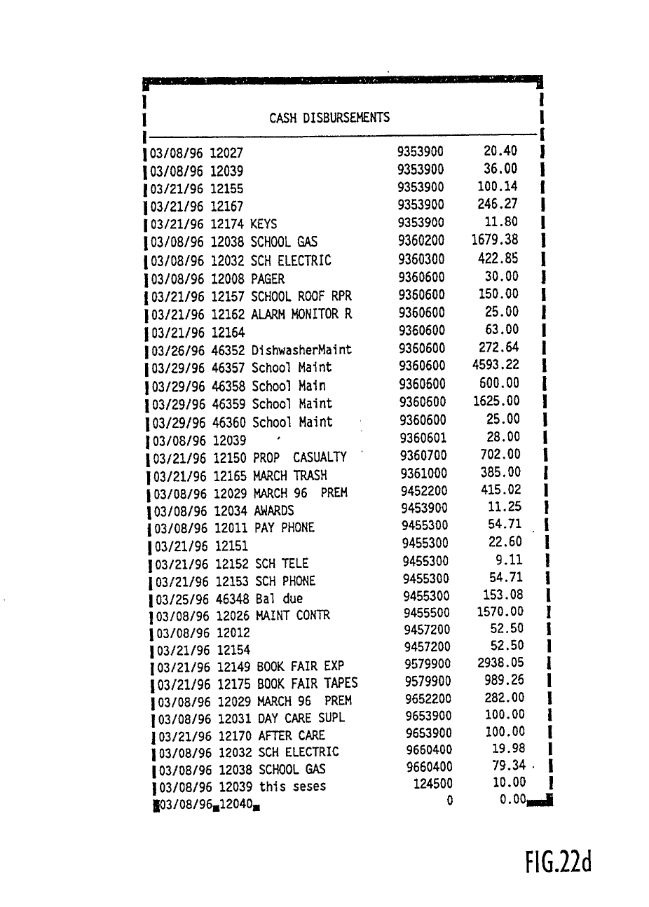

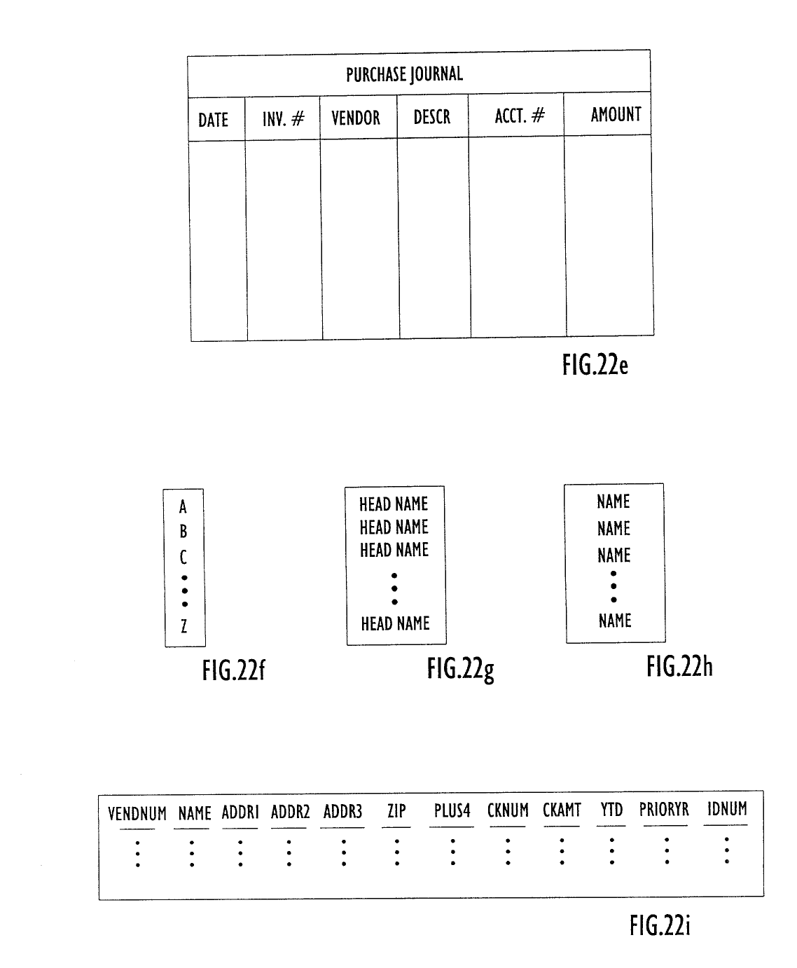

According to the preferred embodiment, the data that is recorded, updated and used by computer program 30 is stored in several data files, including a general ledger file (FIG. 4), a general journal file (FIG. 5), a reports file (FIG. 8), a workpaper file (FIG. 10), a forms file (FIG. 11), a temporary transaction file (FIG. 7), a permanent transaction file (FIG. 9), a control file (FIG. 2), a beginning balance file (FIG. 6), a note file (FIG. 3), a client list file (FIG. 12) and a vendor file (FIG. 22i). The data files are preferably stored on directly accessible media so that they are readily accessed by computer program 30. The data files can alternatively be stored on a server computer, stored off-line, such as on tape or diskette, or stored on any device capable of storing digital data.

According to the preferred embodiment, data is entered into the system via a keyboard 12 connected or attached to machine 10. Many functions are selected or activated via a mouse 11 connected or attached to the machine. Other devices can be utilized to enter the data, such as an optical scanner, bar code reader, or modem, but the present invention is not limited to these devices.

The control file (FIG. 2) stores information for overall control of processing sessions and for transfer (e.g., parameters, text, etc.) between system modules. The system generally provides a predetermined number of records, each of which contains a single field of a predetermined number of characters. The first record contains data which classifies the processing sessions. By way of example, there are three processing session classes, namely write-up, audit and project.

The note file (FIG. 3) stores data for recording notes to be displayed in individual browse ports. A separate record is created for each note. Each record typically includes four fields, (e.g., name, title, num, and awork). The name field stores the name of the note, the title field stores the title of the note, the num field stores an integer which refers to the account to which the note relates, and the awork field stores the contents or text of the note.

The general ledger file (FIG. 4) contains one account record for each general ledger account (e.g., accounts payable, accounts receivable, accrued payroll, etc.) of a record keeping entity. Each record in the general ledger file (FIG. 4) typically includes sixteen data fields (e.g., acnum, name, balfwd, current, January, February, March, April, May, June, July, August, September, October, November and December). The acnum field stores an integer which uniquely identifies the general ledger account within the general ledger file. The name field contains a label which is descriptive of the data contained in the account. The balfwd field stores the dollar amount in the account at the end of the previous accounting period. The current field stores the sum of all the transactions designated in this category during the present accounting period. The fields January through December store the sum of the transactions accumulated during the respective months.

The general journal data file (FIG. 5) typically includes five fields (e.g., date, jnum, oob, jepntr and comment). The date field stores the date of the entry, while the jnum field stores an integer which represents the sequential number of the journal entry. The oob field stores an amount by which the entry is out of balance. Further, the jepntr field stores an integer which is the file record number of the first record of the entry, while the comment field stores an ASCII or text string which is an explanation of the entry.

The beginning balance file (FIG. 6) is used to store the balances of various accounts at the end of the preceding accounting year which are used for calculations and updates (e.g., utilizing carry over balances). A separate record is used for each account which has a carry over balance. Each record typically includes three fields (e.g., acnum, name and balfwd). The acnum field stores the account number of the account, while the name field stores the name of the account. The balfwd field stores the amount carried over from the previous accounting period.

The temporary transaction file (FIG. 7) stores data to represent client transactions occurring in the current month and entered by the record keeping entity. A separate record is created for each transaction. Each record typically includes seven fields (e.g., date, refnum, name, descr, acctnum, amount and source). The date field stores the date of the transaction. The refnum field stores an integer which represents the sequence number of the transaction. The name field is used as needed to store an ASCII or text string which describes the name of a vendor, customer, employee or department. The descr field stores an ASCII or text string which describes the nature of the transaction. The acctnum field stores an integer which represents the account number of the account to which the transaction relates. The amount field stores a numerical value which represents the amount of the transaction. The source field stores a code number which represents the name of the class of the transaction, such as cash receipts, cash disbursements, purchases, sales or payroll. At the end of the month, the records in this file are appended to the end of the permanent transaction file and the contents of this file are deleted.

The reports file (FIG. 8) contains a record for each report designed for a client and a record for each page contained within each report. Each record typically includes four fields (e.g., name, title, page and arpt). The name field contains an ASCII or text string identifying the report or report page, while the title field stores its title. The page field holds an ASCII or text string which represents the page number and the arpt field contains an ASCII or text string version of the array {cform} (described below for FIG. 17b) which in turn contains the format of the data to be displayed on the page.

The permanent transaction file (FIG. 9) contains data which represents client transactions for the preceding months entered by the record keeping entity. A separate record is created for each transaction. Each record typically includes seven fields (e.g., date, refnum, name, descr, acctnum, amount and source). The date field stores the date of the transaction. The refnum field stores an integer which represents the sequence number of the transaction. The name field is used as needed to store an ASCII or text string which describes the name of a vendor, customer, employee or department. The descr field stores an ASCII or text string which describes the nature of the transaction. The acctnum field stores an integer which represents the account number of the account to which the transaction relates. The amount field stores a numerical value which represents the amount of the transaction. The source field stores a code number which represents the name of the class of the transaction, such as cash receipts, cash disbursements, purchases, sales or payroll.

The workpaper file (FIG. 10) contains a separate record for each workpaper defined in the system. Each record typically includes five data fields (e.g., name, source, title, input type and awork). The name field stores the name of the workpaper. The source field stores the source of the data contained in the workpaper. The title field stores the title of the workpaper and the input type field stores the data type of the source data. Further, the awork field stores the content of the workpaper in the form of an ASCII or text string.

The forms file (FIG. 11) stores the data to reproduce a tax form on the screen or to print a page of the form. A separate record in the file is used for each page of the form. Each record typically includes seven fields (e.g., name, frmnu, page, year, taxer, farray and fimage). The name field stores the name of the form, while the frmnu field stores the official form number. The page field stores an integer which represents the page number with the year field storing the appropriate year. The taxer field stores the name of the taxing authority and the farray field stores the data for the contents of the page. Further, the fimage field stores the data for reproducing the picture on the page.

The client/project list file (FIG. 12) stores data for recording the names of clients and projects which have been entered into the system. Two elements that are typically provided for each client or project are a formal name of the client or project and a shortname. The shortname field stores an abbreviated version of the formal name, preferably including not more than eight characters.

### {aLn}

aLn (FIG. 13a) is an array used to display textual information in a generally rectangular area of the monitor referred to herein as a “Browse Port”. The aLn array is comprised of any number of elements, referred to as {ln}, described below. The number of elements is dependent on the requirements of the information to be displayed.

### {ln}

Each ln element (FIG. 13b) includes one or more sub-elements, the first of which must be an ASCII or text string. Additional sub-elements may or may not be used in the ln elements to contain source data or pointers to the data represented depending on the requirements of the calling module. The ASCII or text string is the result of the conversion of the source data to text. The conversion of source data to text is accomplished via a function call (e.g., univproc( )) during the construction of the browse port. The text is the content which is displayed in the browse port.

### {bk}

bk (FIG. 13c) is an array, preferably of twelve elements. The first element, bk [1], contains the name of a data source. The second element, bk [2], contains the name of the browse port. The third element, bk [3], is reserved, but may be utilized for additional capabilities. The fourth element, bk [4], is a two element array for constructing the foot. In particular, the first foot element, bk [4,1], contains a character which is used to construct the foot separator, while the second foot element, bk [4,2], contains an array of values, one for each column in the workpaper. The fifth and sixth elements, bk [5] and bk [6], are used to transfer messages. The seventh element, bk [7], is an array of four elements representing the four comers of the browse port (e.g., top, left, bottom, right). The eighth element, bk [8], contains information to display the heading of the browse port. The heading information is an ASCII or text string used to display the name or other information relating to the browse port. In accordance with the Clipper language, a semi-colon “;” (e.g., ASCII character fifty-nine) is used in the ASCII or text string to separate the lines of the heading where a plural line heading is desired. The ninth element, bk [9], contains code for drawing a border or “box” around the browse port in accordance with the Clipper language. The tenth element, bk [10], is a logical value indicating the presence or absence of a scroll bar. The eleventh element, bk [11], is an array for the construction and display of the scroll bar (e.g., if any). The twelfth element, bk [12], contains an ASCII or text string which is a color code for the browse port in accordance with the Clipper language.

FIG. 14 is a representation of a browse port configured as a client/project menu. The menu includes a list of clients and projects entered into the system. This menu is used as a dispatcher to launch the processing of the selected client or project. The content of this browse port is constructed in accordance with the above descriptions. In this configuration of the browse port, the content is contained in the array aLn (FIG. 13a) and its ln elements are contained in ln arrays described above for FIG. 13b. The text of each constituent ln element is the name of the client or project with datum [1] of that ln element containing the pointer to the selected client or project. There is a separate ln element in the aLn array for each client or project entered into the system.

FIG. 15 is a representation of a browse port configured as a report page menu. The menu includes a list of reports and report pages stored in the system. This menu is used as a dispatcher to launch processing of available workpapers. The content of this browse port is constructed in accordance with the above descriptions. In this configuration of the browse port, the content is contained in the array aLn (FIG. 13a) and its in elements are contained in in arrays as described above for FIG. 13b. The text of each constituent in element is the name of the report or report page with datum [1] of that element containing the pointer to the individual report or report page. There is a separate in element in the aLn array for each report and report page stored within the system.

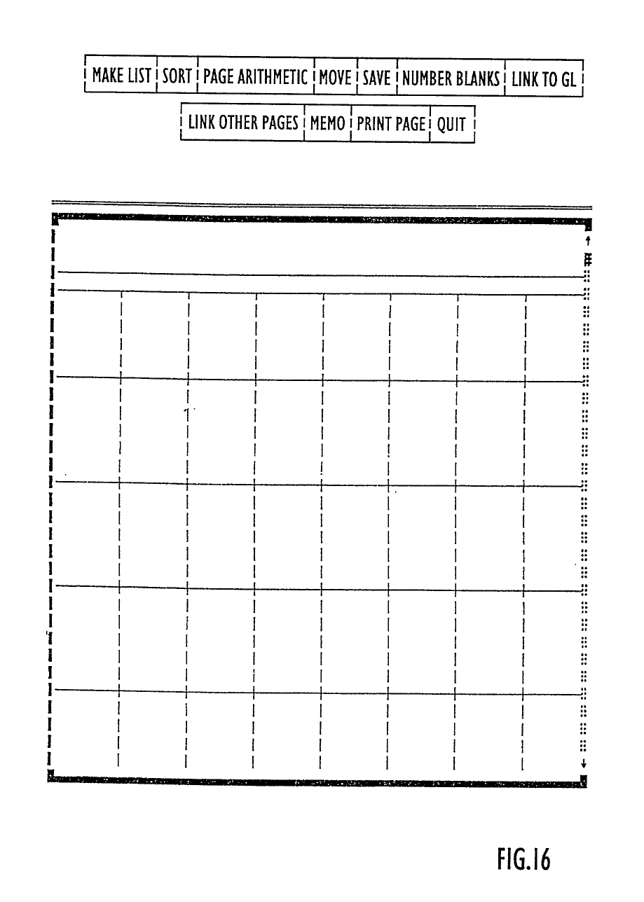

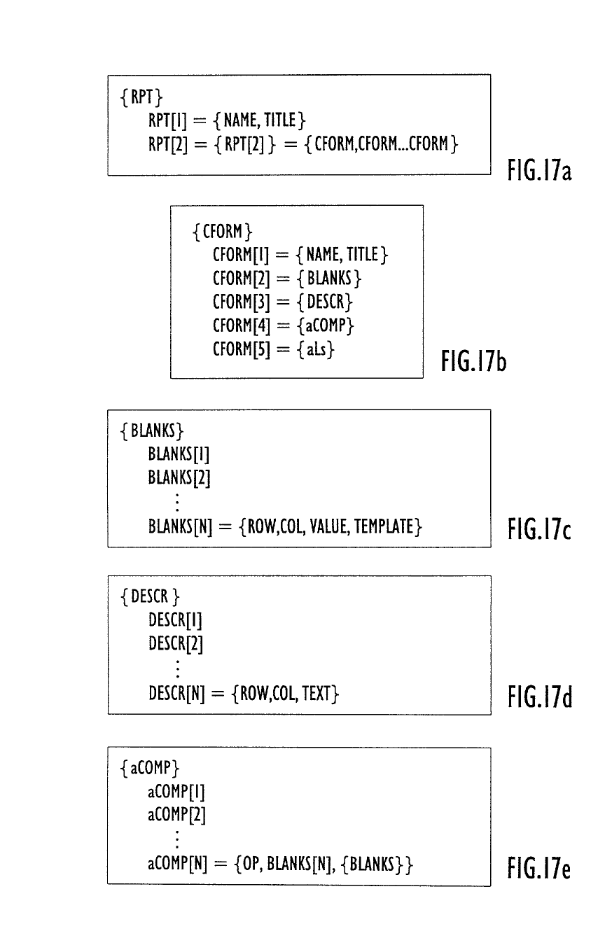

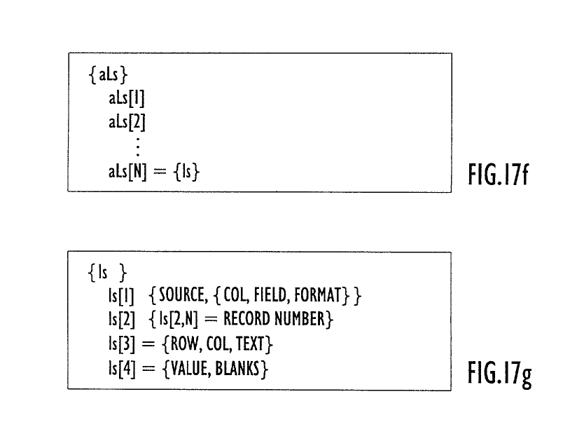

FIG. 16 is a representation of a report construction page screen. The upper portion of the report page screen contains a set of buttons used to activate the various functions for constructing, linking, viewing and otherwise manipulating the pages of a report. The lower portion of the screen includes a browse port which is configured to display, navigate, and manage the contents of a report page. According to the preferred embodiment, a report page includes up to fifty-nine lines, each of which being up to seventy-nine characters wide. The browse port displays up to twenty-eight lines of a page at a time. The remaining lines are accessed by use of the scroll bar provided by the browse port.

### {Rpt}

Rpt (FIG. 17a) is preferably a two element array that identifies a report and contains an array of its pages. The first element, rpt [1], is generally a two element array (e.g., name, title) which contains the name of the report and its title. The second element, rpt[2], is an array of pages. Each page is constructed from information contained in a {cform} array represented in FIG. 17b described below.

### {cform}

Cform (FIG. 17b) is generally a five element array that describes a particular page in a report, the manner in which it is constructed and the manner in which it is displayed. The first element, cform[1], is preferably a two element array (e.g., name, title) containing the name and title of the page. The second element, cform [2], is an array of {blanks} described below. The third element, cform [3], is an array of {descr} described below. The fourth element, cform [4], is an array of {acomp} described below. The fifth element, cform [5], is an array {aLs} described below.

### {blanks}

Blanks (FIG. 17c) is an array used to display data entered by the record keeping entity in pages of a report or form. Each element, blanks[n], preferably includes four elements (e.g., row, col, value, template). The first and second elements, row and col, contain the coordinates for displaying the third element, value, in a predetermined format as described by the fourth element, template. The value can be either date, numerical or textual. Textual values are represented by a predetermined number of ‘X’ characters dependent on the needed size of the value. For numerical values, the templates are represented by a predetermined number of ‘#’ characters with decimal points ‘.’ inserted where required. Dates are represented by the template ‘##/##/##’. Templates are a series of ‘#’ characters or ‘X’ characters used to describe the placement of values as described above.

### {descr}

Descr (FIG. 17d) is an array of descriptions (e.g., descr). Each element, descr[n], is preferably a three element array (e.g., row, col, text). The first and second elements, row and col, contain the coordinates for displaying the third element, the textual content.

### {acomp}

Acomp (FIG. 17e) is an array of formulae. Each formula is preferably a three element array (e.g., op, blank#, {blanks}). The first element ‘op’ contains the mathematical operator (e.g., +, −, *, /) of the formula. The second element, blank#, contains the sequence number of the blanks array element where the result of the formula is to be stored for display. The third element {blanks} is an array which contains the values to be used in the formula.

### {aLs}

aLs (FIG. 17f) is an array of lists. Each list, {ls}, described below is an array containing instructions for constructing and displaying a section of a page of a report or form.

### {ls}

Ls (FIG. 17g) is a multidimensional array preferably including a four primary element array that contains instructions for constructing and displaying a section of a page of a report or form. The first element, ls[1], is generally a two element array, the first element of which specifies the source file, while the second element is an array, of preferably three parameters (e.g., col, field, format) for displaying each line of data in the list. The first parameter, col, is the leftmost column (e.g., as viewed in the figures) on which the line is to be displayed. The second parameter, field, is the field number within the source file from which the data is to be retrieved and the third parameter, format, is the format template for displaying the data. The second element, ls[2], is an array of the record numbers within the source file which are to be displayed. The third element, ls[3], is generally a three element array containing parameters for displaying the foot of the list (e.g., row, col, text). The row and col parameters contain the page coordinates for displaying the text of the foot. The fourth element, ls[4], is preferably a two element array, the first of which contains the numerical value to be displayed, while the second element contains the number of the blanks array element in which the value is to be stored for display.

The present invention typically includes two types of menus, a pull-down menu which includes a single browse port with each option displayed on a separate line and a “button” type menu wherein the options are displayed all on one or more lines. Each button of the button type menu is actually a separate browse port which contains only the heading and the coordinates on the four comers of the button.

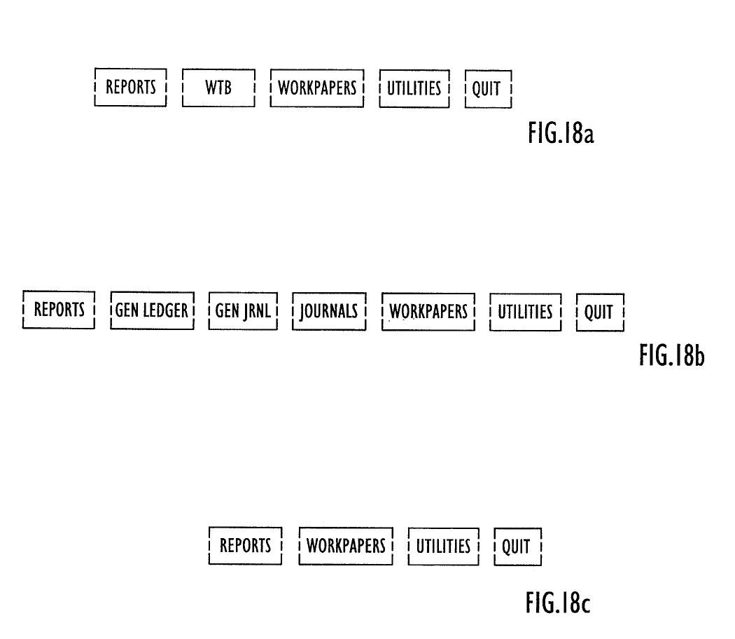

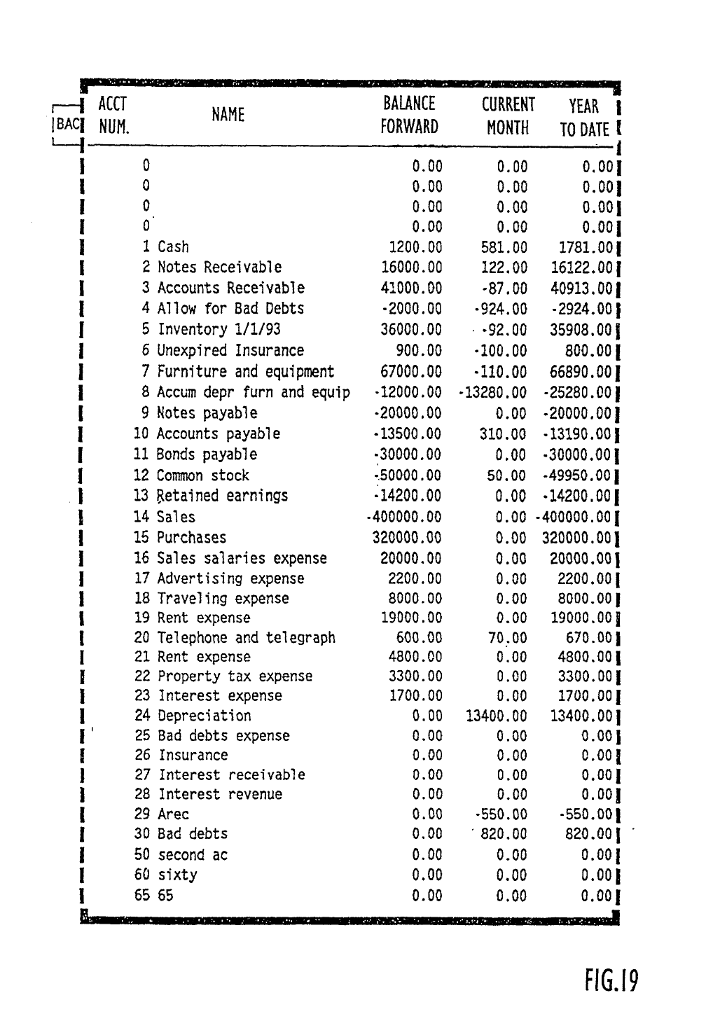

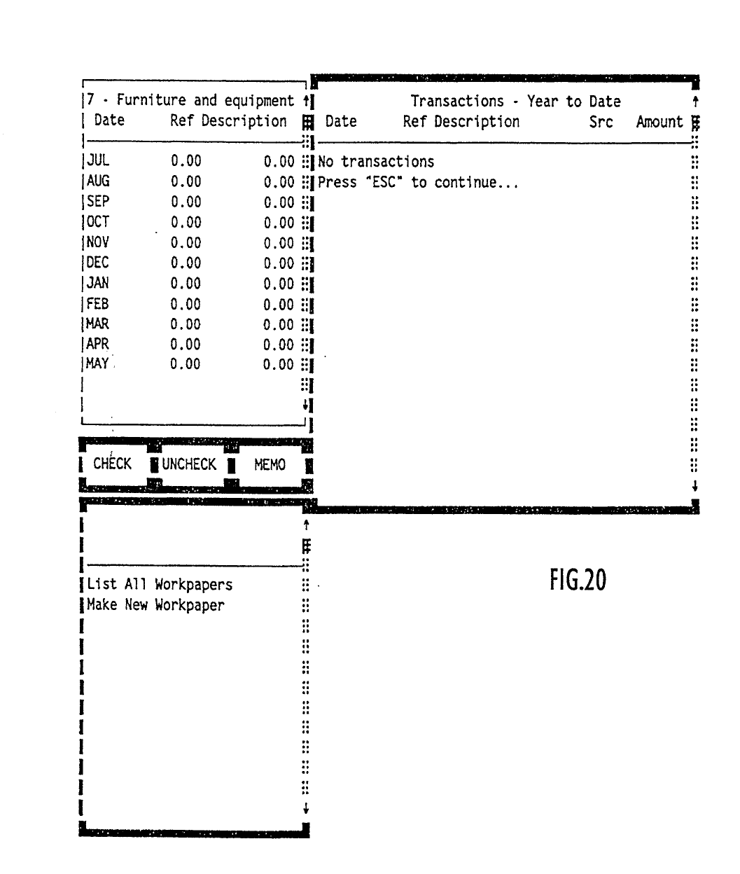

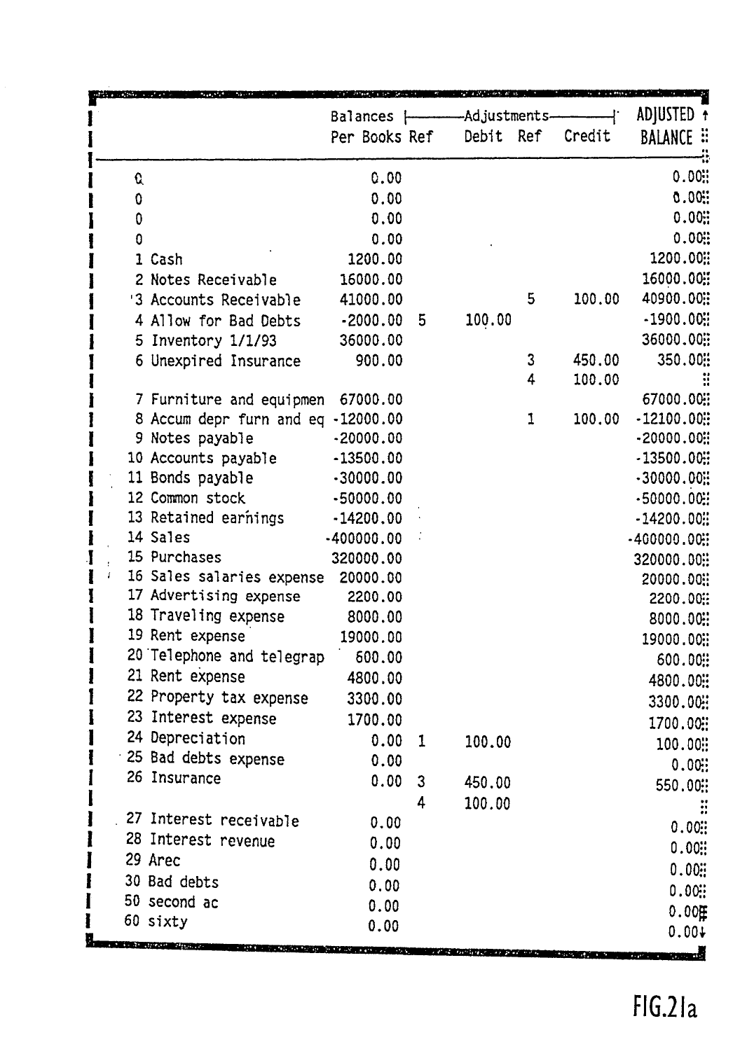

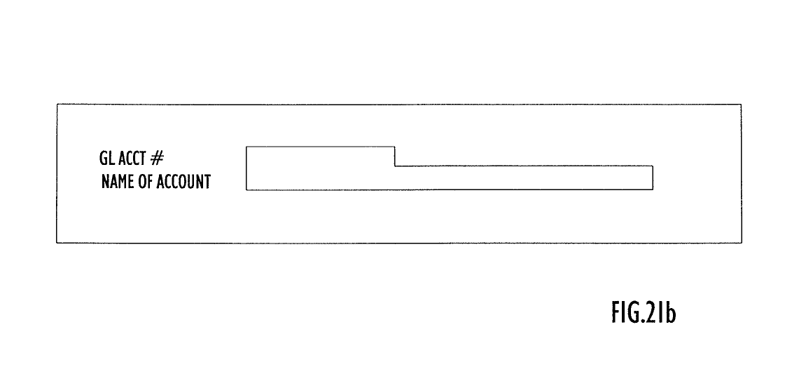

FIG. 18a represents a button type main menu for an audit or compilation client. The menu typically includes five buttons (e.g., reports, WTB, workpapers, utilities and quit). Selection of the reports, workpapers or utilities buttons enables each to produce its own pull-down menu. Selection of the WTB button produces the WTB screen (FIG. 21a), while the quit button returns the user to the client/project selection screen (FIG. 14).

FIG. 18b represents a button type main menu for a Write-Up client. This menu typically includes seven buttons (e.g., reports, gen ledger, gen jrnl, journals, workpapers, utilities and quit). Selection of the reports, journals, workpapers and utilities buttons enables each to produce its own pull-down menu displaying the underlying options for the particular client. Selection of the gen ledger button produces the general ledger screen (FIG. 19). The gen jrnl button produces the general journal screen (FIG. 22a), while the quit button returns the user to the client/project selection screen (FIG. 14).

FIG. 18c represents a button type main menu for a project. This menu typically includes four buttons (e.g., reports, workpapers, utilities and quit). The quit button returns the user to the client/project screen (FIG. 14). Each of the other buttons produces its own pull-down menu as described above.

The general ledger screen (FIG. 19) generally includes five columns of information derived from the general ledger file (FIG. 4). The leftmost column (e.g., as viewed in FIG. 19) is the general ledger account number which comes from the acnum field. The second column is the name of the account and comes from the name field. The third column is the balance forward and comes from the balfwd field. The fourth column is the sum of the current month's transactions and comes from the current field. The fifth column is the year to date column which is the sum of the third and fourth columns.

The general ledger account analysis screen (FIG. 20) includes a browse port configured to list the monthly balances of the selected account, a browse port configured to list all the transactions in the account year-to-date, a browse port configured as a workpaper selector plus a list checker, a list unchecker and a memo selector.

WTB (FIG. 21a) is a screen representation of an accountant or finance professional Working Trial Balance, hereinafter referred to as the ‘WTB’. The WTB typically includes eight columns of information. From left to right (e.g., as viewed in FIG. 21a), the columns contain information relating to the general ledger of the record keeping entity. The first column contains the general ledger account number, the second column contains the name of the general ledger account, and the third column contains the balance of the account according to the record keeping entity's general ledger as of the date of the examination. The fourth, fifth, sixth and seventh columns contain information relating to the adjustments entered by the accountant or finance professional, while the eighth column contains the adjusted balance (which is the proper balance according to the accountant or finance professional). A scroll bar is provided to the right of the eighth column (e.g., as viewed in FIG. 21a).

The General Journal (FIG. 22a) is a representation of the browse port configured to display the adjustments entered into the system. Each adjustment is represented by an adjusting journal entry (AJE) reference number followed by a line for each transaction in the entry. Each transaction is generally displayed in three columns with the browse port preferably containing four columns. The four columns contain from left to right (e.g., as viewed in FIG. 22a), the name of the general ledger account being adjusted, the general ledger account number, and the amount of the adjustment. Debit amounts are displayed in the third column, while credit amounts are displayed in the fourth column. The explanation of the adjustment is displayed in the lines immediately following the transaction lines. If the number of lines in the browse port are not sufficient to completely display all the entries, a scroll bar is provided to facilitate the display of all the entries.

FIG. 22b is a representation of the browse port configured to display a Journal Selection Screen. The Journal Selection Screen is used as a dispatcher to launch processing of the available special journals. Selections are generally displayed for three special journals (e.g., a receipts journal, a disbursements journal and a purchase journal).

FIG. 22c is a representation of the browse port configured to display a Cash Receipts Journal. The Cash Receipts Journal typically includes five columns of information. From left to right (e.g., as viewed in FIG. 22c), the columns contain the date, reference number, description, general ledger account number and amount of each transaction. A scroll bar is provided to the right of the amount column (e.g., as viewed in FIG. 22c). The data for the Cash Receipts Journal is recorded in the temporary transaction file (FIG. 7) during the month in which the cash is received. In particular, the date of the transaction is recorded in the date field, the reference number is recorded in the refnum field, the description is recorded in the descr field, the account number is recorded in the acctnum field and the amount received is recorded in the amount field.

FIG. 22d is a representation of the browse port configured to display a Cash Disbursements Journal. The Cash Disbursements Journal typically includes five columns of information. From left to right (e.g., as viewed in FIG. 22d), the columns contain the date, check number, description, general ledger account number and amount of each transaction. A scroll bar is provided to the right of the amount column (e.g., as viewed in FIG. 22d). The data for the Cash Disbursements Journal is recorded in the temporary transaction file (FIG. 7) during the month in which the cash is disbursed. Specifically, the date of the transaction is recorded in the date field, the check number is recorded in the refnum field, the description is recorded in the descr field, the account number is recorded in the acctnum field and the amount disbursed is recorded in the amount field.

FIG. 22e is a representation of the browse port configured to display a Purchase Journal. The Purchase Journal typically includes six columns of information. From left to right (e.g., as viewed in FIG. 22e), the columns contain the date, invoice number, vendor, description, general ledger account number and amount of each transaction. A scroll bar is provided to the right of the amount column (e.g., as viewed in FIG. 22e). The data for the Purchase Journal is recorded in the temporary transaction file (FIG. 7) during the month in which the transaction is incurred. In particular, the date of the transaction is recorded in the date field, the invoice number is recorded in the refnum field, the vendor name is recorded in the descr field, the account number is recorded in the acctnum field and the amount disbursed is recorded in the amount field.

FIG. 22f is a representation of the browse port configured to display the alphabet screen used in the selection of a name from a series of names contained in a file or an array.

FIG. 22g is a representation of the browse port configured to display a screen which lists every twentieth name, referred to as a header name, derived from an alphabetized array or file.

FIG. 22h is a representation of the browse port configured to display a screen which lists thirty names commencing with the header name selected above.

### {WP}

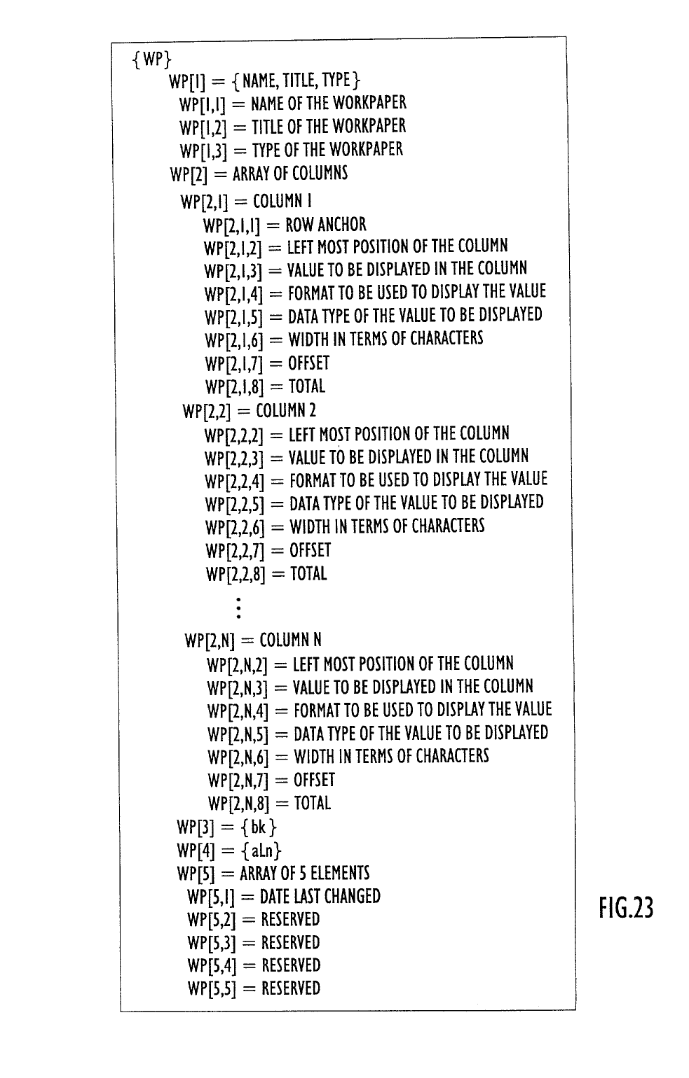

WP (FIG. 23) is a multidimensional array preferably including five primary elements used to contain the data for an accountant or finance professional workpaper. The first element, wp [1], is generally a three element sub-array (e.g., name, title, type) used to contain identification information. In particular, the first sub-array element, wp[1,1], contains the name of the workpaper, the second sub-array element, wp[1,2], contains the full title of the workpaper and the third sub-array element, wp[1,3], contains the type of the workpaper. The second workpaper element, wp[2], is a sub-array wherein each sub-element is used to contain data to describe a corresponding column of the workpaper. The sub-array typically includes eight elements to store attribute data for each column. The first sub-array element for the first column wp[2,1,1] contains the number of the screen row on which the top row of the workpaper is to appear. The second sub-array element for each column, wp[2,n,2], contains the leftmost character position of that column. The third sub-array element for each column, wp [2,n,3], contains the value to be displayed in that column. The fourth sub-array element for each column, wp [2,n,4], contains the format for displaying the value. The fifth sub-array element for each column, wp[2,n,5], describes the data type of the value to be displayed in that column. The sixth sub-array element for each column, wp[2,n,6], specifies the width of that column. The width is described in terms of the number of characters. The seventh sub-array element for each column, wp[2,n,7], specifies the number of character offset for that column. The eighth sub-array element for each column, wp[2,n,8], stores the total of the column for display in the foot of that column. The third element of the workpaper, wp[3], is the array {bk} described above for FIG. 13c. The fourth workpaper element, wp[4], is the array {aLn} described above for FIG. 13a. The fifth workpaper element, wp[5], is preferably a five element array. Specifically the first element, wp[5,1], contains the date of the last change to the workpaper, while remaining elements wp[5,2] through wp[5,5] are reserved.

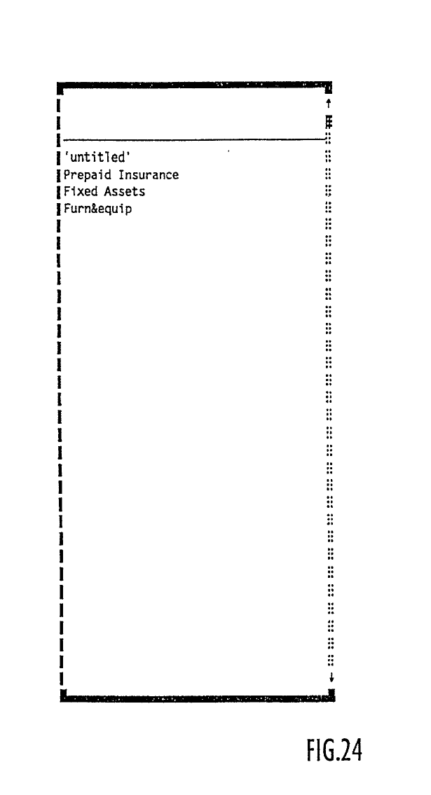

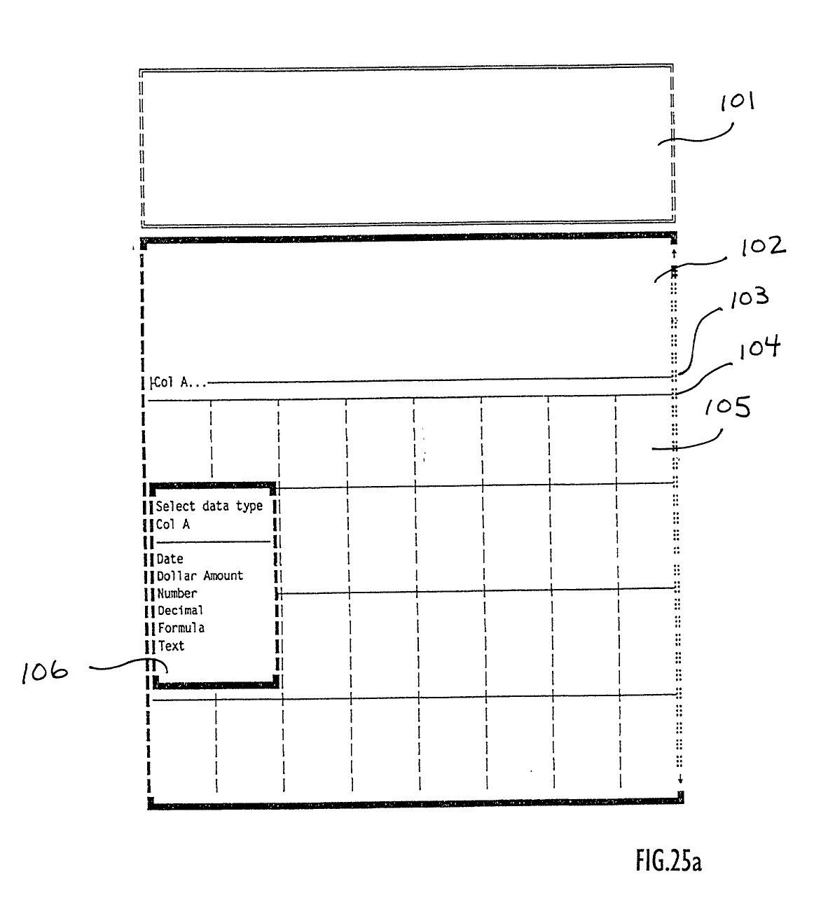

FIG. 24 is a representation of the browse port configured to display a menu of the available workpapers in the system. This menu is used as a dispatcher to launch processing of the available workpapers. In this configuration of the browse port, the content is contained in the array aLn (FIG. 13a) and its in elements (FIG. 13b) are contained in ln arrays as described above. The text of each constituent ln element is the name of the workpaper, while datum[1] of that element contains the pointer to the individual workpaper. There is a separate in element in the aLn array for each workpaper stored within the system. Workpapers are stored in the workpaper file (FIG. 10).

FIGS. 25a and 25b are representations of the workpaper construction screen used during the construction of a new workpaper. The workpaper construction screen typically includes two panels and a floating browse port. An upper panel 101 is used to display instructions for the user. The lower panel 102 covers the balance of the screen and represents the workpaper being constructed. Lower panel 102 generally contains upper and lower lines 103 and 104, a grid 105 and a floating browse port 106. Upper line 103 is an indicator of the columns already assigned and of the next column to be assigned. Lower line 104 illustrates the format templates for displaying the values in each of the assigned columns. Floating browse port 106 appears in the position of the next column to be assigned, contains the data type selector and displays the data types available to be assigned to that column. The data types include date, dollar amount, number, decimal, formula, and text. The format template for the date type is ‘##/##/##’. The format template for the dollar amount is ‘########.##’. The format template for the number data type is ‘######’. The format template for the decimal data type is ‘#.####’. The format template for the formula data type is ‘########.##’. The format template for the text data type is ‘XXXXXXXXXXXXXXXXXXXXXXXX’. FIG. 25a depicts the floating browse port in the position to select a data type for Col A, the leftmost column (e.g., as viewed in the figure) which can be assigned. FIG. 25b depicts the floating browse port in the position to select a data type for Col C, the third column which can be assigned, while Col A has been assigned the date data type and Col B has been assigned the text data type.

### {e}

E (FIG. 26) is an array of preferably seven elements and is used by the system in the construction of records for the temporary and permanent transaction files. The first element, e[1], is used to contain the date of the transaction. The second element, e[2], is used to contain the reference number of the transaction. The third element, e[3], is used to contain the name of a vendor, customer or employee. The fourth element, e[4], is used to contain the description of the transaction. The fifth element, e[5], is used to contain the account number to which the transaction is linked. The sixth element, e[6], is used to contain the amount of the transaction. The transaction can be either a debit or a credit. Debit transactions are recorded as positive amounts. Credit transactions are recorded as negative amounts. The seventh element, e[7], is used to record the code number for the type of journal being represented. New transactions are initially recorded into this array {e}, and are then copied to the temporary transaction file (FIG. 7) when completed.

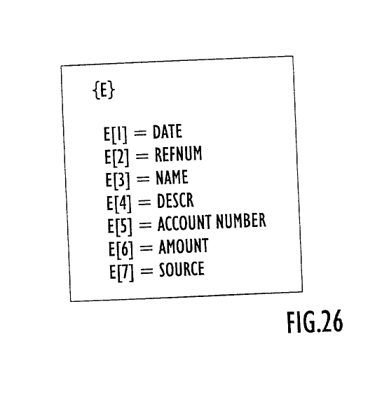

FIG. 27 is a representation of the browse port configured to display a screen which lists the Client/Project type options preferably available in the system (e.g., Write-Up, Audit/Compilation and Project). The Write-Up option is a situation where the user records data from information supplied by the client. The Audit/Compilation option is a situation where the user prepares a financial analysis or report on the basis of the books and records of the client. A project can be any sort of financial analysis or report performed by the record keeping entity.

### Operation of the System

Operation of the system according to the present invention is controlled by computer program 30 (FIG. 1) which includes a number of recordkeeping software procedures for recording data from and writing data to the data files of FIGS. 2-12 and 22i. The data is displayed in a browse port, which is a generally rectangular area of the computer screen. The browse port is constructed by the {aLn} (FIG. 13a) and the {bk} (FIG. 13c) arrays, both of which are described above. Navigation throughout the system is accomplished primarily with mouse 11. Selections are made by clicking with the mouse, placing the mouse cursor on the desired option or function and pressing the left mouse button.

Operation of the system is typically initiated by the user entering the letters ‘TB’ on keyboard 12 (FIG. 1) and pressing the ENTER key. The computer program responds by displaying the Client/Project menu (FIG. 14).

### Client/Project

The Client/Project menu is a list of the clients and projects previously entered into the system and stored in the client list file (FIG. 12). Displayed within a browse port, this is the first thing to appear on screen 14 (FIG. 1) when program 30 is initiated. The user selects a client or project to process by highlighting the selection and pressing the ENTER key, or by clicking on the selection with mouse 11. New clients are entered into the system by pressing the “INS” key while the cursor is in the Client/Project menu. The computer program responds with the “What Type Client/Project” Screen (FIG. 27). The user is generally given three options (e.g., Write-Up, Audit/Compilation or Project). After selecting the appropriate option, the user enters the name of the client or project, whereupon the computer program creates a new sub-directory in that name, changes focus to the newly created sub-directory, creates a series of files in that sub-directory and displays a menu appropriate to the type of Client/Project selected. The files typically created in the new sub-directory are: control.dbf (FIG. 2); enotes.dbf (FIG. 3); glaccts.dbf (FIG. 4); je.dbf (FIG. 5); glbegin.dbf (FIG. 6); gltemp.dbf (FIG. 7); reports.dbf (FIG. 8); gltran.dbf (FIG. 9); and work.dbf (FIG. 10). The menu for a write-up client is represented in FIG. 18b. The menu for an Audit/Compilation client is represented in FIG. 18a. The menu for a Project is represented in FIG. 18c.

### Reports

Selecting “REPORTS” from a main menu causes program 30 to display the Report-Page Menu (FIG. 15). The Report-Page Menu includes of a list of all the reports and report pages previously entered into the system and stored in the reports file (FIG. 8). The system user may select a particular report page or construct a new report page. To select a particular report page, the user clicks on the name of the report page. To construct a new report page or form, the user presses the ‘INS’ key while the cursor is in the Report-Page Menu. Either action causes the program to display the report page construction screen (FIG. 16). The report page construction screen is used to construct or edit a page of a form or report. The upper portion of the screen typically contains a set of buttons which activate separate functions when selected. The lower portion of the screen is occupied by a browse port which contains a grid superimposed on a virtual page. By way of example only, the virtual page is fifty-nine lines long and seventy-nine characters wide. Although the screen displays twenty-eight lines of the page at a time, a scroll bar on the right side of the browse port (e.g., as viewed in FIG. 16) causes the virtual page to scroll, giving access to the full virtual page. The principal function of this screen is to construct or change a form or report page.

The basic operations in the construction of a page are entering the “body of text” which generally remains constant from period to period and creating “blanks” (e.g., fields corresponding with blanks array elements, FIG. 17c) which receive current or variable information from the underlying system and database. The body of text elements are entered by positioning the mouse cursor at the left-most position on the line where the text is to appear and typing the desired text. Each body of text element is stored as a separate element, descr[n], in the {descr} array (FIG. 17d). The page line number (row) is stored in descr[n,1], the column position on the line (col) is stored in descr[n,2], and the text is stored in descr[n,3].

The blanks (and corresponding blanks array elements (FIG. 17c)) receive variable information, primarily from the General Ledger, but sometimes from other sources. Three types of data are preferably supported by the system, namely “numerical”, “text” and “date”. Each data type has its own special template. Numerical blanks are created by placing the mouse cursor at the position where the decimal point is desired, clicking the left mouse button, moving the mouse cursor to the left-most position of the blank and clicking the left mouse button. This establishes the maximum number of significant digits in the blank. The user then moves the mouse cursor to the right most position of the blank and again clicks the left mouse button. This establishes the number of decimal positions to be displayed in the numerical blank. A text blank is created by placing the mouse cursor at the left most character position of the text blank, clicking the left mouse button, moving the mouse cursor to the right most position of the blank and again clicking the left mouse button. This establishes the number of character positions to be displayed in this text blank. A date blank is created by placing the mouse cursor at the left most position of the blank, clicking the left mouse button, moving the mouse cursor to the right, and pressing the “D” keyboard key. This establishes the default template for displaying the date blank.

As the blanks are created, they are identified by number, “n”. Numbers are assigned in the order blanks are created, and since the blanks may be created in any sequence, it is necessary to renumber the blanks so that they are numbered in sequence from top to bottom and from left to right. This is accomplished by pressing the “SORT” button at the top of the report page construction screen before performing any of the “Linking” or “Page Arithmetic” operations described below. The button “Number Blanks” is provided for the users benefit in the event these numbers are needed for identification. By pressing the number blanks button, computer program 30 displays the assigned number for each blank. A colon is displayed at the left-most character position of the blank and is preceded by the number of the blank.

Substantial amounts of data in reports and financial analysis are presented in the form of lists. The present invention provides the capability of preparing lists from data contained within and external of the underlying system. The “Make List” function is called from the report page construction screen (FIG. 16) with the “Make List” button. The user is then instructed to move the mouse cursor to the desired position to type the List Heading, press the left mouse button and to type the heading. After typing the heading, the user presses the enter key and the computer responds with a list of the source fields. The user is then instructed to select the fields which are to be displayed in the list. As the user selects the fields from the source file, the appropriate template is displayed on the line immediately below the heading. A colon is displayed in the left most character position of each template. After all the desired fields have been selected, the user presses the right mouse button to complete this phase of the function. The user is then instructed to “drag” the templates to the appropriate position for the associated columns within the list. After each column has been positioned, the user presses the right mouse button and the computer responds by displaying a list of the source records on the right side of the screen. The user is instructed to select the desired records for display in the list in the sequence in which they are to be displayed. As each selection is made, the appropriate fields of information appear in the columns designated for each record selected.

When the record selection has been completed for the list, the user presses the right mouse button. The computer program thereupon creates a total row by displaying the templates immediately below the last selected element in the list. The computer program also totals all numerical fields in the list and places the totals in their columns. At this point, the user is instructed to delete any undesired totals and to type any desired textual fields. Each template in the total row displays a colon in its left-most character position. The user is instructed to “drag” the templates to their desired position on the page. The surviving numerical templates are inserted into the blanks array and are assigned identification numbers accordingly.

Any body of text or blank can be deleted by placing the mouse cursor on the left-most character position and pressing the “DEL” key. Any blanks or body of text elements may be repositioned on the page by entering the “move mode”. The move mode is entered by placing the mouse cursor on the “Move” button and pressing the left mouse button. Once in this mode, any blank or body of text may be moved by clicking on the left-most character position of its template and “dragging” the template or body of text to the new position. The “move mode” is terminated by pressing the “ESC” key.

The “Link to GL” mode facilitates dynamically linking the blanks to the report. This is done on a page by page basis. Clicking on the “Link to GL” button causes the computer program to display the fields structure of the General Ledger (FIG. 4). From this list, the user can select the desired field to be linked to the Report blanks. When the field has been selected, the user can then click on a particular blank and the computer program displays a trial balance showing the acnum number, name, and amount in the field selected. The user then completes the link to the blank by clicking on the desired account. This establishes a permanent link to that blank. When the report page is viewed or printed, the amount in the selected field of that particular general ledger account is displayed in that particular blank of the report page.

Data can be imported from other pages with the “Link Other Pages” mode. The user initiates this mode by clicking on the “Link Other Pages” button. The program then prompts the user to click on the blank to receive the data. After the user designates the blank to receive the data, the program displays a list of pages which are eligible for linking. The user clicks on the desired page and the program displays that page and prompts the user to select the blank which contains the data to be linked. The “Link Other Pages” mode is terminated after the user makes that selection. The “Page Arithmetic” mode facilitates mathematical operations within a page of a report or a form. To initiate the “Page Arithmetic” mode, the user clicks on the “Page Arithmetic” button. In the “Page Arithmetic” mode, all the mathematical operations are performed in a similar manner. In particular, the user places the mouse cursor on the left most character position of the blank which is to receive the results of the operation and presses the left mouse button. The user then places the mouse cursor on the left most character position of each of the blanks which are to be included in the operation pressing the left mouse button each time. The addition operation is completed by pressing the “+” key. The subtraction operation is completed by pressing the “−” key. The multiplication operation is completed by pressing the “*” key, and the division operation is completed by pressing the “/” key.

The grid on the virtual page is provided only for guidance and alignment purposes during the construction of the report page. Any page can be printed at any time by selecting that page from the report page menu and clicking on the “Print Page” button. Only the body of text and data contained in the blanks is printed (i.e., the grid does not print). Selecting the ‘Memo’ button from the report page screen permits the user to write a memorandum which is stored in the note file (FIG. 3) and can subsequently be displayed on the virtual page. To create the memo, the user clicks the memo button, and then places the mouse cursor at the position on the virtual page where the upper left corner of the memo is to be positioned. The user then presses and holds down the left mouse button and moves the mouse cursor to the position where the lower right corner of the memo is to appear. The program draws and redraws a rectangle on the screen so long as the left button is held down. When the left mouse button is released, the rectangle is frozen into the memo configuration and the user is prompted to enter the name of the memo. The user types in the name of the memo terminating the name by pressing the enter button. The cursor is then positioned in the body portion of the memo configuration where the user can type the body on the memo. The memo creation operation is terminated by pressing the ‘ESC’ key on the keyboard.

After any changes are made to the logic or format of any page, those changes can be saved by clicking on the “Save” button. The linkages, lists, arithmetical functions and memos created become permanent, unless subsequently changed, and reflect the new values in the underlying system throughout all subsequent accounting cycles. This facilitates the automatic preparation and updating of periodic reports.

### Tax Form Preparation

Tax forms are essentially special purpose reports designed by various taxing authorities. These reports are stored in the reports file (FIG. 11) and have operations similar to the Reports module described above. To operate as a tax form preparation system, it is simply a matter of importing an image of the tax form or constructing one independently, and substituting the image of that tax form for the body of text and adding the logic as described above. Blanks need to be created at the appropriate coordinates, and page arithmetic needs to be provided by tax experts. These specialized tax form reports can then be used for mass distribution. The ultimate user would then only need to link the blanks to their subject data in accordance with their needs.

### General Ledger

There are generally two types of books maintained by economic entities, namely ledgers and journals. Journals are books of original entry where transactions and selected other events are initially recorded. Various amounts are transferred to the ledgers from these books of original entry. A general ledger is the primary book of a record keeping entity including all of the asset, liability, owners equity, revenue, and expense accounts. Each account usually has a separate page. Economic events or transactions are recorded in these accounts to reflect the effects of these events on each of the accounts in the system. According to the present invention, the general ledger is initiated by the system user selecting the “GEN LEDGER” option from the client main menu (FIG. 18b). This causes the computer program to open the general ledger file (FIG. 4). The information from the general ledger file is used by computer program 30 to create the “GEN LEDGER” browse port (FIG. 19). The general ledger account number displayed in the first column of the browse port is obtained from the acnum field of the general ledger file (FIG. 4). The name and balance per books or balance forward columns are displayed in the second and third columns of the general ledger screen and are obtained from the name and balfwd fields of the general ledger file (FIG. 4). Data for the fourth column is obtained from the current field of the general ledger file. Data in the fifth column is the sum of the amounts in the third and fourth columns. Navigation and manipulation of the general ledger data is provided via mouse 11 and the scroll bar. The scroll bar is provided to the right of the fifth column (e.g., as viewed in FIG. 19).

Analysis of an individual general ledger account may be obtained by highlighting the account on the general ledger screen and pressing the left mouse button or the “ENTER” key on keyboard 12. The computer responds by producing the general ledger account analysis screen (FIG. 20).

New accounts may be added to the list of accounts by positioning the mouse cursor in one of the first three columns of the general ledger screen (FIG. 19) and pressing ‘INS’, the insert key, on keyboard 12.

New adjusting journal entries may be added to the general journal by placing the mouse cursor in the fourth or fifth columns and pressing ‘INS’, the insert key. This causes the computer program to display the ‘General Journal’ screen as described below with a new AJE number and the cursor positioned for the next entry.

### Working Trial Balance (WTB)

A working trial balance, herein referred to as ‘WTB’, is an informal device used by accountants or other finance professionals for accumulating and sorting information needed for the preparation of financial statements. The WTB provides considerable assurance that all the details related to the preparation of reports have been properly brought together. According to the present invention, construction of a WTB (FIG. 21a) is initiated by the system user selecting the ‘WTB’ option from the audit/compilation main menu (FIG. 18a). In response to the selection of WTB, computer program 30 opens three computer files, namely the general journal data file (FIG. 5), the general ledger file (FIG. 4) and the temporary transaction file (FIG. 7). The information from these files is used by the computer program to create the WTB browse port (FIG. 21a). The general ledger account number displayed in the first column of the WTB (FIG. 21a) is obtained from the acnum field of the general ledger file (FIG. 4). The name and balance per books or balance forward displayed in the second and third columns of the WTB (FIG. 21a) are obtained from the name and balfwd fields of the general ledger file (FIG. 4). Data for the fourth, fifth, sixth and seventh columns of the WTB (FIG. 21a) are obtained from the temporary transaction file (FIG. 7). Debit transactions are displayed in WTB columns four and five, while credit transactions are displayed in WTB columns six and seven. Data for the fourth and sixth columns of the WTB is obtained from the refnum field of the temporary transaction file (FIG. 7), and data for the fifth and seventh columns is obtained from the amount field of the temporary transaction file. The adjusted balance information displayed in the eighth column of the WTB (FIG. 21a) is computed based on the information contained in the third, fifth and seventh columns of the WTB (FIG. 21a).

New accounts may be added to the WTB by positioning the mouse cursor in one of the first three columns and pressing ‘INS’, the insert key. This causes the computer program to display the add account screen (FIG. 21b) which prompts the user to enter the name and account number for the new account. Navigation and manipulation of the WTB is provided via the mouse and the scroll bar. A scroll bar is provided to the right of the eighth column (e.g., as viewed in FIG. 21a) to access accounts that do not fit onto the screen. Adjusting journal entries maybe added by placing the mouse cursor in the fourth, fifth, sixth, or seventh columns of the WTB and pressing ‘INS’, the insert key. This causes the computer program to display the ‘General Journal’ described below with a new AJE number and the cursor positioned for the next entry. A particular adjusting journal entry (AJE) may be displayed by positioning the mouse cursor on the reference number of the adjustment or on its amount and pressing the left mouse button. The computer program then displays the referenced adjusting entry in its own browse port.

A list of the workpapers linked to a particular account maybe displayed by positioning the mouse cursor in one of the first three columns on the line of the account and pressing the left mouse button. A workpaper may be selected from this list by clicking on its name in the list.

### Journals

Journals are books of original entry wherein transactions and selected other events are initially recorded. Various amounts are transferred from the books of original entry to the ledgers. Most record keeping entities use special journals to record various types of transactions and events. The present invention may include several special journals, such as a Cash Receipts Journal (FIG. 22c), a Cash Disbursements Journal (FIG. 22d) and a Purchase Journal (FIG. 22e). The Cash Receipts Journal is used to record all cash received. The Cash Disbursements Journal is used to record all cash paid including cash purchases. The Purchase Journal is used to record all purchases made on account.

### General Journal

A General Journal (FIG. 22a) is used by record keeping entities to record transactions and events which cannot be recorded in the special journals. Specifically, data for the General Journal is stored in two files, namely the general journal file (FIG. 5) and the temporary transaction file (FIG. 7). The general journal file (FIG. 5) contains a separate, sequentially numbered record for each journal entry created by the system user. The temporary transaction file (FIG. 7) contains an individual record for each transaction in each journal entry.

The General Journal browse port is initiated by selecting the GEN JRNL option from the main menu (FIG. 18b). To create a new journal entry, the system user presses the ‘INS’ key while the mouse cursor is in the General Journal browse port. Computer program 30 creates the next sequential record in the general journal file (FIG. 5), assigns the sequence number to the jnum field and assigns the effective financial date to the date field. The computer program then displays the general journal browse port (FIG. 22a) with the cursor in the account number position prompting the user to enter a general ledger account number. The system user then enters a number using keyboard 12 attached to computer 10. The computer program searches the general ledger file to ascertain that this is a valid general ledger account number. If the number is valid, the computer program creates a new transaction record in the temporary transaction file (FIG. 7), assigns the sequence number to the refnum field, assigns the effective date to the date field, assigns the general ledger account number to the acctnum field, assigns the general ledger account name to the descr field and assigns the value of ‘8’ to the source field. The computer program positions the cursor in the amount column. The system user is prompted to enter an amount. The transaction records can reflect either debit or credit entries. Debit entries are represented as positive numbers and are displayed in the third column (FIG. 22a), while credit entries are represented as negative numbers and are displayed in the fourth column. The system user enters an amount preceded by a minus sign if a credit is to be entered otherwise the entry is recorded as a debit. Computer program 30 immediately “posts” the transaction to the WTB, adjusts the ending balance column and the amount is added to the current field of the general ledger account indicated in the acctnum field. After all transactions of an adjusting journal entry have been created, the system user presses the ‘ESC’ key at which time the computer program displays a template for typing the explanation for the adjusting entry. The system user types the explanation in the template and presses the ‘ESC’ key to indicate the completion of the explanation. The computer program responds by recording the explanation in the comment field of the general journal record, creating a new record to the general journal file and adding a blank row to the end of the general journal browse port.

In the conduct of audits, compilations and similar engagements, accountants or other finance professionals prepare entries to adjust the balances obtained from their client general ledgers. These adjusting entries take substantially the same form as the general journal entries described above. An accountant or other user, working from the WTB (FIG. 21a) presses the ‘INS’ key while the mouse cursor is in the fourth, fifth, sixth or seventh columns. Computer program 30 creates the next sequential record as described above. Instead of posting the entry to the General Ledger, the program posts the entry to the WTB.

### Cash Receipts Journal

A Cash Receipts Journal is used by record keeping entities to record all cash received. The Cash Receipts Journal is displayed in a browse port (FIG. 22c). The Cash Receipts Journal is initiated by selecting the RECEIPTS JOURNAL option from the Journal Selection screen (FIG. 22b). Computer program 30 then displays the Cash Receipts Journal browse port with the cursor in position to record a new transaction. The computer program automatically inserts the last date used in the date field and inserts the next sequential reference in the refnum field. The mouse cursor is automatically positioned in the description field ready for the user to type the description for the transaction. The user then has the option to change either or both the date and reference number by pressing the left arrow once for the reference number or twice for the date. Alternatively, the user can just record the description. After the user enters the description and presses the enter key, the cursor advances to the appropriate position to record the general ledger account number. After entering the account number and pressing the enter key, the computer program verifies the validity of the entered account number. If the account number is not valid, the program asks the user if this is to be a new account. The user then has the option to enter the name of the new account if that is the intention. Otherwise, the user deletes the entry and re-enters a valid account number. After the user enters a valid account number, the cursor is advanced to the amount field where the user can enter the amount. After the amount is entered, the transaction is automatically recorded in the temporary transaction file (FIG. 7) and linked to the designated general ledger account. The program then creates a new line below the entered transaction. If the cursor is already at the bottom of the browse port, all previous transactions displayed in the browse port are shifted up one line and the new line is created at the bottom. The entered date, reference number and description are copied in the new line and the cursor is positioned at the account number field. This facilitates entering “split” entries for cash receipts. If the entered transaction is the last or only transaction for the entry, the user presses the enter key again and the computer program increments the reference number in the new transaction, initializes the description field to blank characters and positions the cursor in the description field ready for the next entry. All cash receipt transactions are initially stored in the temporary transaction file and are displayed in the Cash Receipts Journal browse port. At the end of the month, the cash receipts are totaled and the total cash receipts are posted to the appropriate month field of the general ledger cash account. All the temporary transactions are copied to the permanent transaction file and the temporary transaction file is emptied.

### Cash Disbursements Journal

A Cash Disbursements Journal is used by record keeping entities to record all cash payments. The Cash Disbursement Journal is displayed in a browse port (FIG. 22d). The Cash Disbursements Journal is initiated by selecting the DISBURSEMENTS JRN option from the Journal Selection screen (FIG. 22b). Computer program 30 then displays the Cash Disbursements Journal browse port with the cursor in position to record a new transaction. The computer program automatically inserts the last date used in the date field and inserts the next check number in the refnum field. The mouse cursor is automatically positioned in the description field ready for the user to type the payee for the transaction. The user then has the option to change either or both the date and reference number by pressing the left arrow once for the reference number or twice for the date. Alternatively, the user can just record the payee. After the user enters the payee and presses the enter key, the cursor advances to the position to record the general ledger account number. After entering the account number and pressing the enter key, the computer program verifies the validity of the entered account number. If the account number is not valid, the program asks the user if this is to be a new account. The user then has the option to enter the name of the new account, if that is the intention. Otherwise, the user deletes the entry and re-enters a valid account number. After the user enters a valid account number, the cursor is advanced to the amount field where the user can enter the amount. After the amount is entered, the transaction is automatically recorded in the temporary transaction file (FIG. 7) and linked to the designated general ledger account. The program then creates a new line below the entered transaction. If the cursor is already at the bottom of the browse port, all previous transactions displayed in the browse port are shifted up one line and the new line is created at the bottom. The entered date, check number and payee are copied in the new line and the cursor is positioned at the account number field. This facilitates entering “split” entries for cash disbursements. If the entered transaction is the last or only transaction for the entry, the user presses the enter key again and the computer program increments the check number in the new transaction line, initializes the description field with blank characters and positions the cursor in the description field ready for the next entry. All cash disbursement transactions are initially stored in the temporary transaction file and are displayed in the Cash Disbursement Journal browse port. At the end of the month, the cash disbursements are totaled and the total cash disbursements are posted to the appropriate month field of the general ledger cash account. All the temporary transactions are copied to the permanent transaction file and the temporary transaction file is emptied.

### Purchases Journal

A Purchase Journal is used by a record keeping entity to record all purchases on account. The Purchase Journal is displayed in a browse port (FIG. 22e). The Purchase Journal is initiated by selecting the PURCHASE JRN option from the Journal Selection screen (FIG. 22b). The computer program responds by displaying the alphabet index (FIG. 22f). The user then moves the mouse cursor to the letter with which the vendor name begins and presses the left mouse button. The computer program responds by displaying a list of indexed header names (FIG. 22g) commencing with the selected letter. From this list, the user selects a header name. The header names include the names of every twentieth vendor in the vendor file (FIG. 22i). The computer responds by displaying a sequential list (FIG. 22h) of up to thirty vendors commencing with the header name. This list typically includes the name of the targeted vendor. The user then selects the desired vendor and the computer program responds by displaying the Purchase Journal browse port (FIG. 22e). The bottom line of the purchase journal displays a partially entered purchase transaction (not shown). The date field reflects the current date as the purchase date, and the vendor field reflects the vendor name. The mouse cursor is automatically positioned in the invoice number field ready for the user to type the invoice number of the transaction. After the user types the invoice number and presses the enter key, the computer program automatically moves the cursor to the description field. After the user types the description and presses the enter key, the cursor advances to the appropriate position to record the general ledger account number. After entering the general ledger account number and pressing the enter key, the computer program verifies the validity of the entered account number. If the account number is not valid, the program asks the user if this is to be a new account. The user then has the option to enter the name of the new account, if that is the intention. Otherwise, the user deletes the entry and re-enters a valid account number. After the user enters a valid account number, the cursor is advanced to the amount field where the user can enter the amount.

After the amount is entered, the transaction is automatically recorded in the temporary transaction file (FIG. 7) and linked to the designated general ledger account. The transaction is also linked to a corresponding vendor account in the vendor file (FIG. 22i). The vendor file includes a record for each vendor included in the system. Each record is associated with a vendor and generally contains twelve fields (e.g., vendnum, name, addr1, addr2, addr3, zip, plus4, cknum, ckamt, ytd, prioryr and idnum). The vendnum field contains a unique number identifying an associated vendor. The name field contains the name of the associated vendor. Fields addr1, addr2, addr3, zip and plus4 contain address information for the associated vendor (e.g., street address, city, state, country, zip, zip extension, etc.). The cknum field is used to reflect the number of the currently processed check to the associated vendor, while the ckamt field is used to store the amount of that currently processed check. The ytd field is used to store the total of all checks to the associated vendor during the current year. The prioryr field is used to store the total of all checks to the associated vendor during the preceding year. The idnum field is used to store the federal identification number of the associated vendor.

Once the transaction is recorded in the temporary transaction file and linked to the corresponding general ledger and vendor accounts, the program then creates a new line below the entered transaction. If the cursor is already at the bottom of the browse port, all previous transactions displayed in the browse port are shifted up one line and the new line is created at the bottom. The entered date, vendor name, invoice number and description are copied in the new line and the cursor is positioned at the account number field. This facilitates entering “split” entries for the purchase. If the entered transaction is the last or only transaction for the vendor, the user presses the enter key and the computer program displays the alphabet index screen ready to repeat the above process. When all the purchases have been entered, the user terminates this process by pressing the ‘ESC’ key, thereby returning to the main menu (FIG. 18b). All purchase transactions are initially stored in the temporary transaction file and are displayed in the Purchase Journal browse port. At the end of the month, the purchase transactions are totaled and the total purchase amount is posted to the appropriate month field of the general ledger vendor account. All the temporary transactions are copied to the permanent transaction file and the temporary transaction file is emptied.

### Workpapers

Many accountant or other finance professional workpapers and financial analysis are prepared in the form of a columnar worksheet. These are frequently emulated in a structure commonly referred to as a spreadsheet. A spreadsheet is essentially a set of columns containing various types of information arranged in some sort of formal pattern arrangement. Specifically, the system stores data for a worksheet in array {WP} as described above for FIG. 23. Data for the columns is stored in a sub-array WP[2], and numbered sequentially as wp[2,1], wp[2,2], . . . wp[2,n]. The columns are constructed for the workpaper in a left to right sequence and are labeled alphabetically for display purposes, where Col A corresponds to wp[2,1], Col B corresponds to wp[2,2], Col C corresponds to wp[2,3] . . . etc. The attributes of each column are preferably assigned to an eight element array, wp[2,n,1] through wp[2,n,8] as described above for FIG. 23. Some of these attributes are assigned by the computer program as part of the construction process. The first attribute of Col A, wp[2,1,1], is assigned the screen row position where the worksheet is to be displayed. The second attribute of each column, wp[2,n,2], is assigned a value which represents the relative position of the left-most character of the column's format template. The third attribute of each column, wp[2,n,3], is assigned the value to be displayed in that column. The fourth attribute of each column, wp[2,n,4], is assigned the format template for displaying the value to be placed in the column. There are generally six data types for the format templates (e.g., date, dollar amount, number, decimal, formula and text). The applicable format template for the date type is ‘##/##/##’. The format template for the dollar amount type is ‘#######.##’. The format template for the number type is ‘######’. The format template for the decimal data type is ‘#.####’. The format template for the formula data type is ‘#######.##’. The format template for the text type is ‘XXXXXXXXXXXXXXXXXXXXXXXXX’. The fifth attribute of each column, wp[2,n,5], is assigned a numeric value which represents the data type for the data to be contained in the column. In accordance with the American Standard Code for Information Interchange (ASCII): the numeric value assigned for date type is 68; the numeric value assigned for dollar amount type is 78; the numeric value assigned for number type is 78; the numeric value assigned for decimal type is 78; the numeric value assigned for formula type is 78; and the numeric value assigned for text type is 84. The sixth attribute of each column, wp[2,n,6], is assigned a numeric value expressing the width of the column. The seventh attribute of each column, wp[2,n,7], is assigned a value which expresses any additional character positions to offset the display of the column. The eighth attribute of each column, wp[2,n,8], is assigned a value which represents the total of the column.

Construction of a workpaper is initiated by the system user selecting the “WORKPAPERS” option from the client's main menu (FIGS. 18a, 18b, and 18c). The computer program then displays a “Pull-Down” menu (FIG. 24) of the workpapers previously created within the system (e.g., and stored in the workpaper file, FIG. 10) for the client being processed. To construct a new workpaper, the system user presses the ‘INS’ key and the computer program displays a workpaper construction screen (FIG. 25a). The workpaper construction screen typically includes two blank panels 101 and 102, a column designator 103, a column format template 104, a grid 105 and a data type selector 106. Columns are assigned to the workpaper by the system user selecting a data type from the data type selector 106. The user places the mouse cursor on the desired data type and presses the left mouse button. The computer program responds by adding the chosen template to the column format template 104 and advancing data type selector 106 to the next column position. FIG. 25b represents a workpaper construction screen after the date data type has been assigned to column A and the text data type has been assigned to column B. The data type selector is sitting on the position ready for an assignment to column C. The system user terminates the construction process by pressing the ‘ESC’ key. At this point the system user is prompted to enter a name for the workpaper, whereupon the computer program ‘saves’ the configuration of the workpaper.

Entering, changing, adding, and deleting data in the workpaper is described. Initially, the computer program provides space for approximately thirty lines of data in the workpaper data space and enters the ‘process workpaper’ mode. The workpaper data space is defined by wp[4] or as the array aLn described above. The data can be changed by the system user by navigating to the data cell, placing the mouse cursor over the cell and pressing the ‘ENTER’ key. The computer program responds by opening a data entry template and allowing the system user to change the data via the keyboard. The computer program automatically recomputes all other cells which are affected by the change as well as all affected column totals. Additional lines of data can be created by placing the mouse cursor at the point where the line is to be added and pressing the “INS” key on keyboard 12. Any line of data can be deleted by placing the mouse cursor over the line and pressing the “DEL” key on keyboard 12.

It will be appreciated that the embodiments described above and illustrated in the drawings represent only a few of the many ways of implementing a financial processing system and method. Further, while the above description contains many specifications, these should not be construed as limitations on the scope of the invention, but rather as an exemplification of preferred embodiments thereof. Many other variations are possible.

In the description of a report page described above for FIG. 16 and the operation thereof, an alternative embodiment of the present invention could empower the user to specify other dimensions. Also, a different number of lines could be specified to be displayed in the ensuing browse port.

A workpaper could be used to collect information from a stock quoting source.

Another workpaper could be configured to contain the financial information to describe the data necessary for an investment portfolio and the report module could be used to import this information and manipulate it to report the status of the investments at any point in time. The profitability and many other analysis of the investments could be calculated and reported thereon.

The compiled version of the present invention occupies approximately 800 Kilobytes of memory. The amount of information which can permanently be stored on computer chips is increasing. Accordingly, a complete operating system including the present invention may be stored on a single chip. Such an implementation makes possible the creation of a computer on a chip. Many benefits will ensue therefrom including the capability of instant on application. Further capabilities accrue when combined with other technologies, such as the set top box for TV applications and the wireless telephone.

It is to be understood that the present invention may be implemented by any quantity of any type of computer or processing system including software developed in any suitable computing language performing the above-described functions. The functions may be distributed in any fashion among any quantity of computers or hardware and/or software modules. The computer system and software may include and/or be compatible with any suitable operating system (e.g., DOS, Windows, etc.). Further, the software of the present invention maybe developed in any of the above described or other computer languages by one of ordinary skill in the art based on the functional description and data structures disclosed in the specification and illustrated in the drawings. Moreover, the software may be modified in any fashion capable of performing the above-described functions.

The software of the present invention may be available in any suitable storage device or medium (e.g., floppy disk, CD-ROM, DVD, etc.) and/or may be downloaded in the form of carrier waves from a bulletin board and/or site on a network (e.g., Internet). The software may reside on any quantity of computer systems, while plural computer systems including the software may be local or remote from each other and communicate via any suitable communications medium (e.g., LAN, WAN, Internet, cables, modems, etc.).

The arrays may include any quantity of dimensions and elements of any type, and may store any desired data in any desired position within the array. The data may be stored in various other types of data structures for manipulation and storage by the system, such as linked lists, stacks, queues, files, etc. The data maybe stored in any quantity or types of files, data structures or databases arranged in any desired fashion. These storage structures may store any desired information arranged in any fashion. The system may utilize, format and process data in any type or form (e.g., numeric, date, text, ASCII, EBCIDIC, float, integer, string, etc.). The templates may include any format, characters or symbols, and may identify any value type or format in any desired fashion.

The browse ports, screens, menus, files and data structures of the present invention may be arranged in any fashion and may include any quantity and type of information. The screens and browse ports may be of any shape or size and display any desired information at any locations. The screens, browse ports, reports and workpapers may include any quantity of lines, rows, columns and/or cells, may be arranged in any fashion and may contain any quantity or type of information disposed at any locations. The system may interact with the user via any types of input devices (e.g., keyboard, mouse, voice recognition, touch screen, etc.), and may respond to any type of user input (e.g., any mouse buttons, any keyboard keys, voice commands, etc.). The system may utilize any quantity of any type of menu or other interface (e.g., graphical user interfaces (GUI), etc.) to navigate and/or initiate any application and/or select and/or enter any desired data. Further, the screens may utilize any quantity or any type of scrolling or other input device disposed at any locations on the screens to scroll or otherwise navigate the screens.

The system data may include any identifiers or symbols to indicate the data type (e.g., debits, credits, dollar amounts, foreign currency, dates, account numbers, etc.). The workpapers and reports may be arranged in any fashion and include any quantity of any desired data. The workpapers may be configured by a user to perform any suitable arithmetic operations on any quantity of user selected cells, while the cells may receive data entered by a user or be linked to any stored data. These workpaper arithmetic and linking functions may be accomplished in any suitable manners, such as those described above for the reports. The system and/or software may include any quantity of the individual functions described above or any combinations of those functions.

It is to be understood that the terms “right”, “left”, “top”, “bottom”, “side”, “lower”, “upper” and the like are used herein merely to describe points of reference and do not limit the present invention to any particular configuration or orientation. Further, the description herein of software performing specific functions relates to a computer or processing system performing those functions under software control.

The present invention is not limited to the applications disclosed herein, but may be utilized to provide any types of business, financial or other processing, statements and/or forms.

From the foregoing description it will be appreciated that the invention makes available a novel financial processing system and method wherein a computer system includes software to design, install, create, update and report financial information in diverse applications including trial balance, general ledger, financial analysis, financial reports, tax returns and workpapers (e.g., spreadsheets).

Having described preferred embodiments of a new and improved financial processing system and method, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A financial processing system for receiving and storing financial information associated with an entity and selectively processing said information to provide an indication of a financial status of said entity, said system comprising:
journal means for receiving and storing financial information associated with an entity event and entered by a user in the form of a financial journal entry;
ledger means for organizing financial information in accordance with a plurality of accounts with each account associated with a financial attribute of said entity, wherein said ledger means includes ledger storage means for receiving said financial information from said journal means and storing said financial information based on an account associated with said entity event; and
presentation means for arranging financial information associated with said entity in the form of a spreadsheet selectively configurable by and for display to said user.

2. The system of claim 1 further including balance means for accessing said stored financial information and processing said accessed information to produce a financial statement in the form of a trial balance.

3. The system of claim 2 wherein said balance means further includes balance adjustment means for facilitating entry of adjustment information by said user in the form of an adjusting entry and for processing said adjustment information to update said trial balance.

4. The system of claim 2 wherein said journal means includes:
general journal means for receiving and storing financial information entered by said user and associated with a particular entity event;
posting means for transferring said financial information associated with said particular event to said ledger means for storage based on an account associated with said particular event; and
balance update means for processing said financial information associated with said particular event to update said trial balance.

5. The system of claim 1 wherein said journal means includes:
journal receipt means for receiving and storing financial information entered by said user and associated with receipt of cash by said entity and for linking said receipt information to a corresponding account; and
posting means for accumulating said receipt information associated with a predetermined time interval to produce a total of said cash receipts for said interval for transference to said ledger means for storage in accordance with said corresponding account.

6. The system of claim 1 wherein said journal means includes:
journal disbursement means for receiving and storing financial information entered by said user and associated with cash payments by said entity and for linking said payment information to a corresponding account; and
posting means for accumulating said payment information associated with a predetermined time interval to produce a total of said cash payments for said interval for transference to said ledger means for storage in accordance with said corresponding account.

7. The system of claim 1 wherein said journal means includes:
journal purchase means for receiving and storing financial information entered by said user and associated with purchases on account from a vendor by said entity and for linking said purchase information to a corresponding account and a corresponding vendor account; and
posting means for accumulating said purchase information associated with a predetermined time interval to produce a total of said purchases for said interval for transference to said ledger means for storage in accordance with said corresponding account.

8. The system of claim 1 further including operation means for displaying a plurality of system operations to said user and initiating a displayed operation in response to selection of that operation by said user.

9. The system of claim 1 further including report means for displaying financial information associated with said entity in the form of a report having at least one page and selectively configurable by said user.

10. The system of claim 9 wherein said report means includes configuration means for facilitating configuration of said report by said user.

11. The system of claim 10 wherein said configuration means includes:
ledger link means for selectively linking at least one field of said report to financial information associated with an account, wherein said ledger link means includes link retrieval means for retrieving said linked information and storing that information within said at least one report field; and
arithmetic means for selectively processing financial information within said report in accordance with mathematical functions selected by said user.

12. The system of claim 11 wherein said configuration means further includes:
page link means for selectively linking at least one field of a first report page to information contained within a field of another report page, wherein said page link means includes page retrieval means for retrieving said linked page information and storing that information within said at least one field of said first report page; and
field relocation means for selectively transferring information contained within a first field of a report page to another field on that page.

13. The system of claim 12 wherein said configuration means further includes:
list means for facilitating selection and processing of financial information within a list and enabling placement of said list within said report;
memorandum means for facilitating entry of textual information in the form of a memorandum for display with said report; and
print means for facilitating printing of said report.

14. The system of claim 1 further including form means for facilitating generation of a financial form by said system having at least one page and selectively configurable by said user.

15. The system of claim 14 wherein said form means includes configuration means for facilitating configuration of said form by said user.

16. The system of claim 15 wherein said configuration means includes:
ledger link means for selectively linking at least one field of said form to financial information associated with an account, wherein said ledger link means includes link retrieval means for retrieving said linked information and storing that information within said at least one form field; and
arithmetic means for selectively processing financial information within said form in accordance with mathematical functions selected by said user.

17. The system of claim 16 wherein said configuration means further includes:
page link means for selectively linking at least one field of a first form page to information contained within a field of another form page, wherein said page link means includes page retrieval means for retrieving said linked page information and storing that information within said at least one field of said first form page; and
field relocation means for selectively transferring information contained within a first field of a form page to another field on that page.

18. The system of claim 14 wherein said financial form includes a tax form.

19. A program product apparatus having a computer readable medium with computer program logic recorded thereon for receiving and storing financial information associated with an entity and selectively processing said information to provide an indication of a financial status of said entity, said program product apparatus comprising:
a journal module to receive and store financial information associated with an entity event and entered by a user in the form of a financial journal entry;
a ledger module to organize financial information in accordance with a plurality of accounts with each account associated with a financial attribute of said entity, wherein said ledger module includes a ledger storage module to receive said financial information from said journal module and to store said financial information based on an account associated with said entity event; and
a presentation module to arrange financial information associated with said entity in the form of a spreadsheet selectively configurable by and for display to said user.

20. The apparatus of claim 19 further including a balance module to access said stored financial information and process said accessed information to produce a financial statement in the form of a trial balance.

21. The apparatus of claim 20 wherein said journal module includes:
a general journal module to receive and store financial information entered by said user and associated with a particular entity event;
a post module to transfer said financial information associated with said particular event to said ledger module for storage based on an account associated with said particular event; and
a balance update module to process said financial information associated with said particular event to update said trial balance.

22. The apparatus of claim 19 wherein said journal module includes:
a journal receipt module to receive and store financial information entered by said user and associated with receipt of cash by said entity and to link said receipt information to a corresponding account; and
a post module to accumulate said receipt information associated with a predetermined time interval to produce a total of said cash receipts for said interval for transference to said ledger module for storage in accordance with said corresponding account.

23. The apparatus of claim 19 wherein said journal module includes:
a journal disbursement module to receive and store financial information entered by said user and associated with cash payments by said entity and to link said payment information to a corresponding account; and
a post module to accumulate said payment information associated with a predetermined time interval to produce a total of said cash payments for said interval for transference to said ledger module for storage in accordance with said corresponding account.

24. The apparatus of claim 19 wherein said journal module includes:
a journal purchase module to receive and store financial information entered by said user and associated with purchases on account from a vendor by said entity and to link said purchase information to a corresponding account and a corresponding vendor account; and
a post module to accumulate said purchase information associated with a predetermined time interval to produce a total of said purchases for said interval for transference to said ledger module for storage in accordance with said corresponding account.

25. The apparatus of claim 19 further including a report module to display financial information associated with said entity in the form of a report having at least one page and selectively configurable by said user.

26. The apparatus of claim 25 wherein said report module includes:
a ledger link module to selectively link at least one field of said report to financial information associated with an account, wherein said ledger link module includes a link retrieval module to retrieve said linked information and store that information within said at least one report field; and
an arithmetic module to selectively process financial information within said report in accordance with mathematical functions selected by said user.

27. The apparatus of claim 26 wherein said report module further includes:
a page link module to selectively link at least one field of a first report page to information contained within a field of another report page, wherein said page link module includes a page retrieval module to retrieve said linked page information and store that information within said at least one field of said first report page; and
a field relocation module to selectively transfer information contained within a first field of a report page to another field on that page.

28. The apparatus of claim 19 further including a form module to facilitate generation of a financial form having at least one page and selectively configurable by said user.

29. The apparatus of claim 28 wherein said form module includes:
a ledger link module to selectively link at least one field of said form to financial information associated with an account, wherein said ledger link module includes a link retrieval module to retrieve said linked information and store that information within said at least one form field; and
an arithmetic module to selectively process financial information within said form in accordance with mathematical functions selected by said user.

30. The apparatus of claim 29 wherein said form module further includes:
a page link module to selectively link at least one field of a first form page to information contained within a field of another form page, wherein said page link module includes a page retrieval module to retrieve said linked page information and store that information within said at least one field of said first form page; and
a field relocation module to selectively transfer information contained within a first field of a form page to another field on that page.

31. A carrier signal having computer program logic embedded therein for receiving and storing financial information associated with an entity and selectively processing said information to provide an indication of a financial status of said entity, said carrier signal comprising:
a journal module to receive and store financial information associated with an entity event and entered by a user in the form of a financial journal entry;
a ledger module to organize financial information in accordance with a plurality of accounts with each account associated with a financial attribute of said entity, wherein said ledger module includes a ledger storage module to receive said financial information from said journal module and to store said financial information based on an account associated with said entity event; and
a presentation module to arrange financial information associated with said entity in the form of a spreadsheet selectively configurable by and for display to said user.

32. The carrier signal of claim 31 further including a balance module to access said stored financial information and process said accessed information to produce a financial statement in the form of a trial balance.

33. The carrier signal of claim 32 wherein said journal module includes:
a general journal module to receive and store financial information entered by said user and associated with a particular entity event;
a post module to transfer said financial information associated with said particular event to said ledger module for storage based on an account associated with said particular event; and
a balance update module to process said financial information associated with said particular event to update said trial balance.

34. The carrier signal of claim 31 wherein said journal module includes:
a journal receipt module to receive and store financial information entered by said user and associated with receipt of cash by said entity and to link said receipt information to a corresponding account; and
a post module to accumulate said receipt information associated with a predetermined time interval to produce a total of said cash receipts for said interval for transference to said ledger module for storage in accordance with said corresponding account.

35. The carrier signal of claim 31 wherein said journal module includes:
a journal disbursement module to receive and store financial information entered by said user and associated with cash payments by said entity and to link said payment information to a corresponding account; and
a post module to accumulate said payment information associated with a predetermined time interval to produce a total of said cash payments for said interval for transference to said ledger module for storage in accordance with said corresponding account.

36. The carrier signal of claim 31 wherein said journal module includes:
a journal purchase module to receive and store financial information entered by said user and associated with purchases on account from a vendor by said entity and to link said purchase information to a corresponding account and a corresponding vendor account; and
a post module to accumulate said purchase information associated with a predetermined time interval to produce a total of said purchases for said interval for transference to said ledger module for storage in accordance with said corresponding account.

37. The carrier signal of claim 31 further including a report module to display financial information associated with said entity in the form of a report having at least one page and selectively configurable by said user.

38. The carrier signal of claim 37 wherein said report module includes:
a ledger link module to selectively link at least one field of said report to financial information associated with an account, wherein said ledger link module includes a link retrieval module to retrieve said linked information and store that information within said at least one report field; and
an arithmetic module to selectively process financial information within said report in accordance with mathematical functions selected by said user.

39. The carrier signal of claim 38 wherein said report module further includes:
a page link module to selectively link at least one field of a first report page to information contained within a field of another report page, wherein said page link module includes a page retrieval module to retrieve said linked page information and store that information within said at least one field of said first report page; and
a field relocation module to selectively transfer information contained within a first field of a report page to another field on that page.

40. The carrier signal of claim 31 further including a form module to facilitate generation of a financial form having at least one page and selectively configurable by said user.

41. The carrier signal of claim 40 wherein said form module includes:
a ledger link module to selectively link at least one field of said form to financial information associated with an account, wherein said ledger link module includes a link retrieval module to retrieve said linked information and store that information within said at least one form field; and
an arithmetic module to selectively process financial information within said form in accordance with mathematical functions selected by said user.

42. The carrier signal of claim 41 wherein said form module further includes:
a page link module to selectively link at least one field of a first form page to information contained within a field of another form page, wherein said page link module includes a page retrieval module to retrieve said linked page information and store that information within said at least one field of said first form page; and
a field relocation module to selectively transfer information contained within a first field of a form page to another field on that page.

43. In a financial processing system having a processor for receiving, storing and processing financial information associated with an entity, a method of maintaining an indication of a financial status of said entity comprising the steps of:
(a) receiving and storing financial information associated with an entity event and entered into said system by a user in the form of a financial journal entry;
(b) organizing financial information, via said processor, in accordance with a plurality of accounts with each account associated with a financial attribute of said entity and storing said entered financial information based on an account associated with said entity event; and
(c) arranging, via said processor, financial information associated with said entity in the form of a spreadsheet selectively configurable by and for display to said user.

44. The method of claim 43 further including the step of:
(d) accessing said stored financial information and processing said accessed information, via said processor, to produce a financial statement in the form of a trial balance.

45. The method of claim 44 wherein said step (d) further includes:
(d.1) facilitating entry of adjustment information into said system by said user in the form of an adjusting entry and processing said adjustment information, via said processor, to update said trial balance.

46. The method of claim 43 wherein step (a) further includes:
(a.1) receiving and storing financial information entered into said system by said user and associated with a particular entity event;
(a.2) storing said financial information associated with said particular event based on an account associated with said particular event; and
(a.3) processing said financial information associated with said particular event, via said processor, to update said trial balance.

47. The method of claim 43 wherein step (a) further includes:
(a.1) receiving and storing financial information entered into said system by said user and associated with receipt of cash by said entity and linking said receipt information to a corresponding account via said processor; and
(a.2) accumulating said receipt information associated with a predetermined time interval, via said processor, to produce a total of said cash receipts for said interval for storage in accordance with said corresponding account.

48. The method of claim 43 wherein step (a) further includes:
(a.1) receiving and storing financial information entered into said system by said user and associated with cash payments by said entity and linking said payment information to a corresponding account via said processor; and
(a.2) accumulating said payment information associated with a predetermined time interval, via said processor, to produce a total of said cash payments for said interval for storage in accordance with said corresponding account.

49. The method of claim 43 wherein step (a) further includes:
(a.1) receiving and storing financial information entered into said system by said user and associated with purchases on account from a vendor by said entity and linking said purchase information to a corresponding account and a corresponding vendor account via said processor; and
(a.2) accumulating said purchase information associated with a predetermined time interval, via said processor, to produce a total of said purchases for said interval for storage in accordance with said corresponding account.

50. The method of claim 43 further including the step of:
(d) displaying financial information associated with said entity in the form of a report having at least one page and selectively configurable by said user.

51. The method of claim 50 wherein step (d) further includes:
(d.1) selectively linking at least one field of said report to financial information associated with an account via said processor;
(d.2) retrieving said linked information via said processor and storing that information within said at least one report field; and
(d.3) selectively processing financial information within said report, via said processor, in accordance with mathematical functions selected by said user.

52. The method of claim 51 wherein step (d) further includes:
(d.4) selectively linking at least one field of a first report page to information contained within a field of another report page via said processor;
(d.5) retrieving said linked page information via said processor and storing that information within said at least one field of said first report page; and
(d.6) selectively transferring information contained within a first field of a report page to another field on that page via said processor.

53. The method of claim 52 wherein step (d) further includes:
(d.7) facilitating selection and processing of financial information within a list and enabling placement of said list within said report via said processor;
(d.8) facilitating entry of textual information in the form of a memorandum via said processor for display with said report; and
(d.9) selectively facilitating printing of said report by said processor.

54. The method of claim 43 further including the step of:
(d) facilitating generation of a financial form by said system, wherein said form has at least one page and is selectively configurable by said user.

55. The method of claim 54 wherein step (d) further includes:
(d.1) selectively linking at least one field of said form to financial information associated with an account via said processor;
(d.2) retrieving said linked information via said processor and storing that information within said at least one form field; and
(d.3) selectively processing financial information within said form, via said processor, in accordance with mathematical functions selected by said user.

56. The method of claim 55 wherein step (d) further includes:
(d.4) selectively linking at least one field of a first form page to information contained within a field of another form page via said processor;
(d.5) retrieving said linked page information via said processor and storing that information within said at least one field of said first form page; and
(d.6) selectively transferring information contained within a first field of a form page to another field on that page via said processor.
